(19) United States
(12) Patent Application Publication
(10) Pub. No.: US 2003/0099014 A1
(43) Pub. Date: May 29, 2003

(54) System and method for optimized design of an optical network

(76) Inventors: Will A. Egner, Allen, TX (US); Vinay Kumar Reddy Mallapu, Richardson, TX (US); Yindong Zheng, Plano, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 10/133,695

(22) Filed: Apr. 25, 2002

Related U.S. Application Data
(60) Provisional application No. 60/287,030, filed on Apr. 26, 2001.

(51) Int. Cl. H04J 14/02

(52) U.S. Cl. 359/124

(57) ABSTRACT

A method of designing a network configuration comprising designating placement of a plurality of network components within a first network configuration having a plurality of sites and a respective physical link interconnecting two of the plurality of sites, modeling conveyance of an optical signal along a light path between at least two sites of the first network configuration, the modeled optical signal comprising a calculated signal attribute at a plurality of locations, the value of the calculated signal attribute at any of the plurality of locations dependent upon designation of a set of the network components included within the light path, determining a position for potential placement of at least one of an amplification stage and a regeneration stage within the first network configuration is provided.

### TECHNICAL FIELD OF THE INVENTION

This invention relates to optical networks and, more particularly, to a system and method for optimizing design of a dense wave division multiplexing fiber optic network.

### BACKGROUND OF THE INVENTION

Today, network service providers face intense competition that has driven down the revenues per unit bandwidth. Network operators accordingly have a great interest in reducing overall network capital and operating costs. Line cards, common equipment, and optical line amplifiers (OLAs) all contribute significantly to the capital cost of fiber optic backbones, such as dense wavelength division multiplexing (DWDM) networks. Conventional DWDM engineering tools, such as routing and wavelength assignment (RWA) algorithms, rely on simple distance-based computations and do not accurately reflect equipment constraints or cost implications. Existing tools do not provide comprehensive light path modeling and equipment modeling. Thus, optical network designers are burdened with decisions that are inherently complicated in nature. Poorly designed networks can cost service providers hundreds of thousands of dollars in additional capital costs. To date, leading optical equipment vendors have not provided engineering tools that facilitate cost optimization of DWDM networks.

### SUMMARY OF THE INVENTION

In accordance with an embodiment of the present invention, a method of designing a dense wave division multiplexing network comprised of a plurality of sites comprising specifying a plurality of traffic demands to be serviced by the network, specifying a plurality of equipment components that are available to be disposed within the network to facilitate delivery of the traffic demands, assigning at least one of the plurality of components for respective placement within each of the plurality of network sites, the assigned components defining a first network configuration, computing a network cost value dependent on the selected equipment components, comparing the computed cost with an alternative cost calculated from an alternative network configuration, and selecting a final network configuration from the first network configuration and the alternative network configuration is provided.

In accordance with another embodiment of the present invention, a method of designing a network configuration comprising designating placement of a plurality of network components within a first network configuration having a plurality of sites and a respective physical link interconnecting two of the plurality of sites, modeling conveyance of an optical signal along a light path between at least two sites of the first network configuration, the modeled optical signal comprising a calculated signal attribute at a plurality of locations, the value of the calculated signal attribute at any of the plurality of locations dependent upon designation of a set of the network components included within the light path, determining a position for potential placement of at least one of an amplification stage and a regeneration stage within the first network configuration is provided.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a block diagram of an algorithm for optimizing network design according to an embodiment of the present invention;

FIG. 2A is a simplified traffic demand schematic for which a network design may be generated according to techniques of the present invention;

FIG. 2B is a simplified schematic of a physical layer of a network design for providing the traffic demands described with reference to FIG. 2A;

FIG. 3 is a simplified block diagram of an origination site that may be disposed within the physical layer described with reference to FIG. 2B;

FIG. 4 is a block diagram of a transit site that may be disposed within the physical layer described with reference to FIG. 2B;

FIG. 5 is a block diagram of a destination site that may be disposed within the physical layer described with reference to FIG. 2B;

FIG. 6 is flowchart depicting an algorithm processing for performing routing and wavelength assignment and network configuration optimization according to an embodiment of the present invention;

FIGS. 7A and 7B are a block diagram of a ring network and a schematic of a directed edge graph that may logically represent the ring network, respectively.

FIG. 8A is a schematic of a network site terminating incoming links;

FIG. 8B is array 620 recording a count of add and drop procedures performed on pairs of lambdas by the site described with reference to FIG. 8A;

FIGS. 9A-9D are respective block diagrams of network sites for processing origination traffic, destination traffic, pass-through traffic, and wavelength converted traffic;

FIG. 10A-10B is a respective block diagram of a logical relationship between a site information data structure and one or more equipment data structures according to an embodiment of the present invention and;

FIG. 11 is a site equipment provisioning flowchart of an automatic equipment engineering subroutine according to an embodiment of the present invention;

FIG. 12 is a flow chart depicting an automatic link engineering procedure according to an embodiment of the present invention;

FIG. 13 is a flowchart of an automatic dispersion compensation routine according to an embodiment of the present invention;

FIG. 14 is a flowchart depicting a subroutine that facilities automated placement of amplification and/or regeneration stages within a network design according to an embodiment of the present invention;

FIG. 15 is a flowchart of a subroutine for performing evaluation of removal of regeneration stages within the network design according to an embodiment of the present invention.

FIG. 16 is a flowchart depicting evaluation of removal of amplification stages within the network design according to an embodiment of the present invention;

FIG. 17 is a flowchart of a variable optical amplification subroutine according to an embodiment of the present invention;

FIG. 18 is a simplified flowchart of an algorithm processing routine performed to evaluate RWA reassignment and the effect thereof on the overall cost of a network design according to an embodiment of the present invention;

FIG. 19 is an exemplary signal trace and network design criteria plot calculated by the network design techniques of the present invention;

FIG. 20 is a cost optimization bar chart that may be generated by the algorithm of the present invention; and

FIG. 21 is block diagram of computer system that may used to execute the algorithm of the present invention.

### DETAILED DESCRIPTION OF THE DRAWINGS

The preferred embodiment of the present invention and its advantages are best understood by referring to FIGS. 1 through 21 of the drawings, like numerals being used for like and corresponding parts of the various drawings.

The computer-aided optical network design of the subject invention facilitates network design by minimizing wavelength usage, optimizing waveband grouping and sequencing, optimizing fiber level switching, and modeling light path characteristics and corresponding signal losses to facilitate a network configuration featuring the most economical cost for specified network performance requirements. By minimizing wavelength usage, equipment costs at the optical layer are reduced by limiting the number of underlying lasers and detectors as well as the requisite common equipment. Additionally, effective reuse of wavelength assignments increases bandwidth utilization thereby allowing for increased capacity available for future services provisioned on the network. Increasing waveband reuse can reduce common equipment costs and provide an increase in overall network capacity. For example, avoiding traffic assignments to wavebands with wavelengths (also referred to herein as service channels and lambdas λ) that must be subjected to optical-to-electrical-to-optical conversions (OEO), such as is required when transmitting wavelengths along an unclear light path, with wavelength assignments that are not subject to similar conversions, OEO and/or optical line amplifier (OLA) equipment quantities may be reduced. Moreover, automated placement of amplification and/or regeneration components within the network design is facilitated by modeling optical signal deterioration that may include signal loss, noise accumulation, and dispersion effects according to an embodiment of the present invention.

The present invention is implemented as an optimization algorithm 10, or program, comprised of one or more sets of computer-executable instructions that is provided with various inputs 20-22 specifying requirements of a particular network design and that provides various outputs upon execution of algorithm 10, as illustrated in the block diagram of FIG. 1. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium now known or later developed, including (a non-exhaustive list): an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The instruction execution apparatus may be any conventional computer system featuring any one of various commercially available processing unit(s).

Inputs 20-22 provided to algorithm 10 may comprise a traffic input 20 defining traffic requirements of the network, a connection attribute input 21 comprising physical attributes of the network, and a resource input 22 comprised of resource specifications of the network. Each input 20-22 may comprise one or more data elements that are conveyed to algorithm 10. For example, traffic input 20 may include one or more data elements defining an average demand, a service type, a peak demand, and/or a quality of service (QoS) parameter such as delay, blocking and/or availability metrics. Attribute input 21 may comprise a plurality of data elements as well, such as a site name, location, and fiber connectivity that defines how various network elements are interconnected. Likewise, resource input 22 may comprise a plurality of data elements including, but not limited to, one or more equipment types and a respective cost associated therewith. Algorithm 10 receives each of inputs 20-22 and determines an optimized network configuration dependent upon wavelength groupings, available equipment, acceptable signal loss, QoS specifications, and/or other network design characteristics as described herein. Optimization is performed by algorithm 10 by minimizing the number of wavelengths supported by the network, evaluation of various clear and unclear light path options and resulting optimization selection between equipment costs and unnecessary OEO regeneration, optimized network configurations resulting in selection between OEO and OLA costs, and/or network configuration optimization based on modeled optical signal characteristics and corresponding reconfiguration of network infrastructures. Moreover, algorithm 10 is constrained by performance attributes for each type of available equipment, acceptable wavelength routing with minimized wavelength conversion, and/or optimized wavelength grouping and sequencing. Algorithm 10 receives and processes inputs 20-22 and provides one or more outputs such as an optimized network map output 30, a network layer output 31 and a site output 32. Network layer output 31 may comprise data elements defining a routing and wavelength assignment (RWA) for each traffic demand and associated QoS provided in an input to algorithm 10. As used herein, RWA refers to a particular route of a network on which a traffic demand is conveyed from a source site of the network to a destination site of the network and includes an identification of the wavelength(s) of which the traffic demand is conveyed along the assigned route. A route, as used herein, refers to a path by which a traffic demand may be conveyed through the physical layer of a network from a source site to a destination site and preferably includes each link, that is fiber, the origination site, destination site, and any intermediate sites therebetween through which the traffic demand is conveyed. A link budget may also be provided for all optimized light paths. Site output 32 may comprise an equipment listing for each site of the network design as well as associated costs of the equipment entities selected for each site. Additionally, add/drop group sequencing may be specified for each site of the network design.

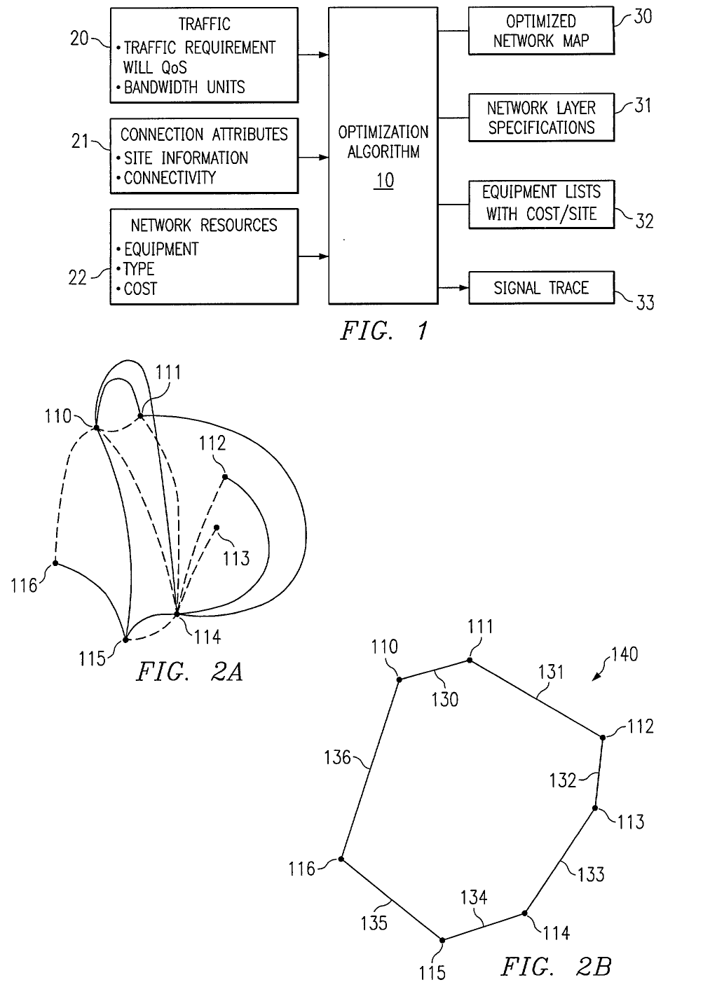

Traffic input 20 preferably specifies parameters defining a bandwidth, protocol, and QoS requirements for a desired service between various site locations of the network design. Parameters of traffic input 20 may be provided to a network designer by a subscriber and may reflect data transfer rates, protocol requirements, and or other traffic demands between two or more sites. Traffic input 20 may be maintained in a text file, or other suitably formatted data structure, and read by algorithm 10. With reference now to FIG. 2A, there is a simplified traffic demand schematic (as defined by traffic input 20) for which a network design may be generated by algorithm 10. In the exemplary network traffic demand schematic, various data traffic demands are defined between seven network sites 110-116. Each traffic demand defined between two sites includes a bandwidth requirement. In the illustrative example, a solid line interconnecting two sites indicates a Gigabit Ethernet (GE) traffic demand and a dashed line illustratively denotes an OC-48 transport service bandwidth requirement. Table A summarizes exemplary traffic demand requirements among nodes 110-116 that may be provided to algorithm 10 via traffic input 20.

TABLE A

| | | | Band- | | Path |
|---|---|---|---|---|---|
| Connectivity | | | width | Quantity | Diversity |
| Traffic Demand 1 | Site 110 | Site 111 | OC48 | 1 | None |
| Traffic Demand 2 | Site 110 | Site 111 | GE | 2 | 1 + 1 |
| Traffic Demand 3 | Site 110 | Site 114 | GE | 4 | None |
| Traffic Demand 4 | Site 110 | Site 114 | GE | 3 | None |
| Traffic Demand 5 | Site 110 | Site 114 | OC48 | 2 | 1 + 1 |
| Traffic Demand 6 | Site 111 | Site 114 | GE | 2 | 1 + 1 |
| Traffic Demand 7 | Site 111 | Site 114 | OC48 | 2 | None |
| Traffic Demand 8 | Site 112 | Site 114 | OC48 | 1 | None |
| Traffic Demand 9 | Site 112 | Site 114 | GE | 1 | None |
| Traffic Demand 10 | Site 113 | Site 114 | OC48 | 2 | 1 + 1 |
| Traffic Demand 11 | Site 114 | Site 114 | OC48 | 1 | None |
| Traffic Demand 12 | Site 114 | Site 115 | GE | 1 | None |
| Traffic Demand 13 | Site 115 | Site 116 | GE | 1 | None |
| Traffic Demand 14 | Site 116 | Site 110 | OC48 | 2 | 1 + 1 |

As shown, traffic input 20 defines traffic demands between various sites and specifies a required bandwidth for each traffic demand, as well as a quantity specification, and a path diversity. Path diversity specifies whether the link is unprotected or protected, that is whether routes may travel over a common physical connection, i.e. fiber, or whether two routes may not share any common physical connections. For example, two traffic demands (traffic demand 1 and traffic demand 2) are defined for transfers between sites 110 and 111. Traffic demand 2 is required to have GE bandwidth capacity and is denoted to have a quantity “2” and a path diversity value of “1+1”. In the illustrative example, a diversity value of “None” denotes an unprotected route while a diversity value of “1+1” denotes a protected route featuring redundancy on both a line side and transmission side, that is redundancy of access cards for interfacing with a subscriber tributary and redundancy of light path (i.e. redundant fibers). Thus, traffic demand 2 requires two different routes, as denoted by the quantity value of “2”, and the traffic for which the two routes are to be provisioned may not travel over the same physical link, as denoted by the diversity value of “1+1”. On the other hand, traffic demand 3 defined for a data transfer requirement between sites 110 and 114 requires four separate routes for data transfers but all traffic may be conveyed over a common physical link, as denoted by the diversity value of “None”. Other redundancy configurations are possible. For example, light path redundancy may be provided by having redundant transmission cards while no redundancy of access cards is provided. Such a redundancy configuration may be denoted by a diversity value of “L1+1” that indicates a configuration featuring a light path diversity.

Bandwidth requirements are defined in traffic input 20 by specifying one of various fiber availabilities. For example, traffic demand 1 is specified to have a bandwidth requirement of OC48. However, the bandwidth requirements of an interconnection may be specified in other formats such as a bit rate or another numerical metric. Common fiber availabilities and associated bit rates that may be used to specify a required bandwidth of a traffic demand are summarized in TABLE B.

TABLE B

| BW Name | Value | Units |
|---|---|---|
| DS0 | 64 | kbps |
| DS1 | +DS0*24 | kbps |
| DS3 | +DS1*28 | kbps |
| OC1 | +DS3 | kbps |
| OC3 | +3*OC1 | kbps |
| OC12 | +12*OC1 | kbps |
| OC48 | +48*OC1 | kbps |
| OC192 | +192*OC1 | kbps |
| 100BaseT | 100000 | kbps |
| GE | +10*100BaseT | kbps |

With reference now to FIG. 2B, there is a simplified schematic of a physical layer 140 of a network design that may be generated by algorithm 10 and that has sufficient capacity to deliver the traffic demands defined by traffic input 20. Physical layer 140 comprises site 110-116 to which traffic demands are defined and physical links 130-136 respectively interconnecting two of sites 10-116. Each link 130-136 generally comprises one or more bi-directional optical fiber pairs. The number of fiber pairs in a particular link 130-136 is dependent upon the traffic demands that may be routed therethrough and is optimized by algorithm 10 in a manner such that the total number of fiber pairs is minimized without adversely effecting the network design, that is without undesirable impacting the network design performance and/or cost. In other words, the number of fiber pairs is one exemplary network parameter that may be manipulated during network design such that the final selection of fiber pairs provides an optimized network infrastructure having the least overall cost while still allowing the network design to meet the traffic demand requirements. Each of sites 110-116 is ‘populated’ (or assigned) with optical network components, such as multiplexers/demultiplexers, amplifiers, etc., by algorithm 10 in a manner such that sites 110-116 have sufficient capabilities to satisfy the network requirements defined by traffic input 20 according to an embodiment of the present invention and as described more fully hereinbelow.

Attribute input 21 provides physical attributes of sites of physical layer 140 and requisite fiber optic link characteristics between sites 110-116. Attribute input 21 may include geographical coordinates, such as a longitude and latitude, for each site location, fiber length, fiber count, and facility size. TABLE C summarizes exemplary site 110-116 information that may be provided by attribute input 21.

TABLE C

| Physical | Resource | Fiber | | | Fiber |
|---|---|---|---|---|---|
| Link Name | Type | Count | Site_A | Site_B | Distance |
| Site_1_to_Site_2 | True_Wave | 2 | 110 | 111 | 10 |
| Site_2_to_Site_3 | True_Wave | 2 | 111 | 112 | 20 |
| Site_3_to_Site_4 | True_Wave | 2 | 112 | 113 | 30 |
| Site_4_to_Site_5 | True_Wave | 2 | 113 | 114 | 10 |
| Site_5_to_Site_6 | True_Wave | 2 | 114 | 115 | 5 |
| Site_6_to_Site_7 | True_Wave | 2 | 115 | 116 | 6 |
| Site_7_to_Site_1 | True_Wave | 2 | 116 | 110 | 9 |

As summarized by TABLE C, the connectivity defined by attribute input 21 may additionally provide a name for each physical link between two sites, a resource type of the link, such as True Wave, a fiber count of the link, the sites that terminate the link and thereby define the connectivity of the link, the fiber distance of the link, as well as other attributes of the physical layer 140.

Each of links 130-136 are respectively terminated by two sites 110-116 and may be referred to as point-to-point links. A typical point-to-point optical link comprises a transmitter (laser), transmission medium (optical fiber), one or more multiplexer/demultiplexers (OMXs) and a receiver (detector). Metropolitan networks have different requirements compared to long haul networks because the distance between nodes are shorter and therefore signal loss may be dominated by OMX losses. Frequent bandwidth grooming, that is the assignment of a traffic demand (or a portion thereof) to a particular bandwidth, and sophisticated link management are required to handle the traffic. Light path design is carried out using individual wavelength power budgets. In optical power budgeting, the optical power is calculated for the total link including the loss at different places along the link and at all systems involved in provisioning of the link. This optical power budgeting is computed for every service channel. Significant losses introduced by network components, or infrastructure, include fiber transmission losses (dB/km), connector losses (dB/con.), splice losses (dB/splice), losses introduced by intermediate link systems, such as an OMX, a power margin for future services, as well as other losses. A requisite optical power at a receiver for a particular link may be estimated by:

P_{R}=Pᵢ−N_{c}l_{c}−Nₛlₛ−Lαₜ−N_{M}l_{M}−M, eq. 1

where N_{C}, N_{S}, N_{M} are the number of connectors, splices and OMX modules, respectively; lc, l_{S}, l_{M} are the loss of connectors, splices and OMX modules, respectively (in dB); L is the length of the fiber; αₜ parameter is the fiber loss per length unit, M is the future margin; and Pi is the output power of the optical source (transmitter). It should be understood that equation 1 is exemplary only and numerous other losses may be estimated as well.

Given the optical power budgeting, the minimum input optical power required (Pᵣ) for a link may be calculated. The link budget computation is used to decide where optical fiber amplification (OFA) should be placed. To calculate the optical power budget for the whole network, decomposition of the network design into point-to-point links and computation of individual link budgets for all physical links is performed according to techniques of the present invention that significantly automates and optimizes design of the network.

Each site 110-116 may have numerous network components disposed therein for performing one or more specific functions. Each network component may be classified according to a general functional class and numerous components may be of a common functional class. For example, numerous manufacturers may respectively produce one or more laser transmitters for performing a common function, namely modulating electrical signals to optical wavelengths for conveyance through physical layer 140. Each such laser may be generally categorized as a transmitter class network component and each laser transmitter will have performance parameter(s), such as maximum output power, sensitivities, etc., that may be collectively stored in a data structure, indexed for retrieval therefrom, and subjected to development of a mathematical model that provides an estimate of the component performance characteristics in a given scenario according to an embodiment of the invention. The present invention utilizes a database of available network components and performance parameters thereof for developing mathematical models of available network components and facilitates automated selection and configuration of components within each site of a network design in a technique that provides a most economical network configuration for required traffic demands of the network. Performance parameters of a particular component, for example, a transmitter, may be obtained by algorithm 10 by including a unique model, or other identifier, that may be used to index parameters of the particular component.

A brief description of some of the most common optical networking components (and a non-exhaustive description of performance parameters thereof that may be modeled to facilitate development of a network design according to the teachings herein) is now provided. The components described, and the performance parameters thereof, are not intended to limit application of the invention and it should be understood by skilled artisans that additional networking components and performance parameters may be substituted for, or implemented in addition to, those described.

Laser and detector circuits perform electrical-to-optical and optical-to-electrical conversions, respectively. The transmitter modulates electrical signals to respective optical wavelengths to be transmitted out of an OMX onto an optical fiber. The detector drops received wavelength signals by passive optical filtering from an OMX and conveys the dropped wavelength through line cards to tributaries, that is customer sites, interfacing with sites of network physical layer 140. The output power of a transmission laser is dependent upon the type of transmitter, which include maximum bit rate transmitters, maximum transmitter power transmitters, minimum transmitter power transmitters, and center wavelength transmitters. Notable performance characteristics of transmission detectors include maximum bit rate, minimum receive level, optical signal-to-noise ratio (the average optical power required to achieve a particular bit error rate at a specified bit rate) requirements, overload (maximum input power acceptable by the receiver), and center wavelength. Each of these characteristics, as well as others, may be modeled and their respective impact on the overall network design performance and cost may be accounted for in the network design process as discussed more fully hereinbelow.

Each OMX module contains passive optical filters that add and/or drop wavelengths destined for a particular site or subscriber tributary. The optical add section contains a band filter and a channel multiplexer (MUX). The optical drop section contains a band filter and a channel demultiplexer (DEMUX). The filter drops specific wavelengths while allowing other wavelengths to pass through the filter. Notable parameters related to OMX performance include insertion loss (port-to-port) and operable add/drop bands.

An OFA may be disposed in a network where the signal is not strong enough to be detected by the receiver detector. Notable parameters related to OFA performance include signal wavelength range (maximum and minimum), minimum input power, maximum input power, minimum output power, maximum output power, and a noise figure.

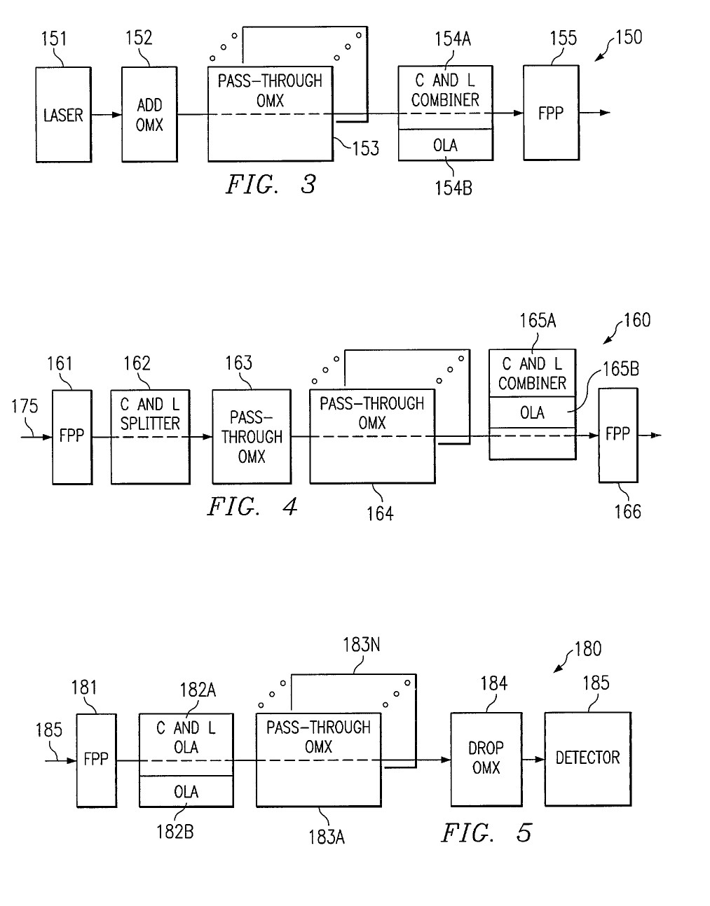

With reference now to FIG. 3, there is shown a site 150 populated with equipment that allows site 150 to operate as an origination (or source) site 150, that is a site of the network design responsible for generating, or otherwise inserting, network traffic into the physical layer 140 for transit thereby. Source site 150 includes a laser transmitter 151 that generates a laser pulse at a given power range. Laser 151 may be one of various commercially available lasers including an OC-48 laser, a Gigabit Ethernet laser, or an OC-192 laser. Laser 151, in general, has a predefined wavelength output that may be added (or input) to a fiber. Laser 151 output may be provided to an OMX 152 that combines, or multiplexes, the wavelength output by laser 151 with other wavelengths within a band range, such as the C-band or L-band. The lambda signal may then pass through a series of OMXs 153A-153N prior to exiting site 150. OMXs 153A-153N are used to add and/or drop other wavelengths at site 150. A waveband combiner 154A may then be used to combine wavelengths into a common band, and the waveband may be input to an OLA 154B to amplify the waveband. Thereafter, the lambda signal passes through a fiber patch panel (FPP) 155 that inserts the wavebands onto a fiber link terminated by site 150.

A transit site is a network site at which a lambda is not required to be added or dropped and an exemplary block diagram of a transit site 160 is shown in FIG. 4. A transit lambda enters transit site 160 through an FPP 161 and may be one of various lambdas included in one or more wavebands that comprise an input optical signal 175. Optical signal 175 can be separated into constituent C band (1525-1565 nm) and L Band (1565-1605 nm) wavelengths by a waveband splitter/combiner 162. Splitter/combiner 162 may be used to reduce signal loss when only C or L band lambdas are added and/or dropped at a particular network site. Optical signal 175 may pass through one or more OMXs 163-164 before being amplified by OLA 165B and recombined by combiner 165A as needed. Thereafter, optical signal 175 exits site 160 through FPP 166. Additionally, wavelength conversion may be performed at transit site 160 and site 160 may be referred to as a conversion site. If Signal 175 enters and exits site 160 on a common wavelength, that is if transit site is part of a ‘clear’ path, a power transfer function must be evaluated in order to accurately estimate signal levels after wavelength conversion. If, however, signal 175 exits site 160 at a different wavelength that that at which it enters site 160 (that is, site 160 is part of an ‘unclear’ path through which signal 175 traverses during transit from the origination site to the destination site), OEO is performed and the signal power level is preferably reset to match that of the original laser output as provided by the origination site. If transit site transit site 160 is not required to perform wavelength conversion, site 160 may be referred to as a pass-through site.

A termination (or destination) site 180 is a network site into which a particular lambda route terminates and from which the lambda is dropped, as shown by the simplified block diagram of FIG. 5. A lambda enters destination site 180 in an optical signal 185 that may include other lambdas in a common waveband and/or additional wavebands. Optical signal 185 is first received by FPP 181 and may be passed to a waveband splitter 182A and/or an OLA 182B. Optical signal 185 may pass through one or more OMXs 183A-183N that each respectively drop a waveband from signal 185. The lambda that is destined for site 180 is dropped, along with any other lambdas sharing a common waveband with the destination lambda, upon entry of signal 185 into drop OMX 184 that filters the waveband including the destination lambda. Thereafter, the destination lambda is input into detector 185 that may extract the subscriber data from the carrier lambda.

It should be understood that each of sites 110-116 may be populated with network components that allow the particular site to operate as a source site, a transit site, and/or a destination site and such classification of sites 110-116 is dependent on traffic conditions thereof.

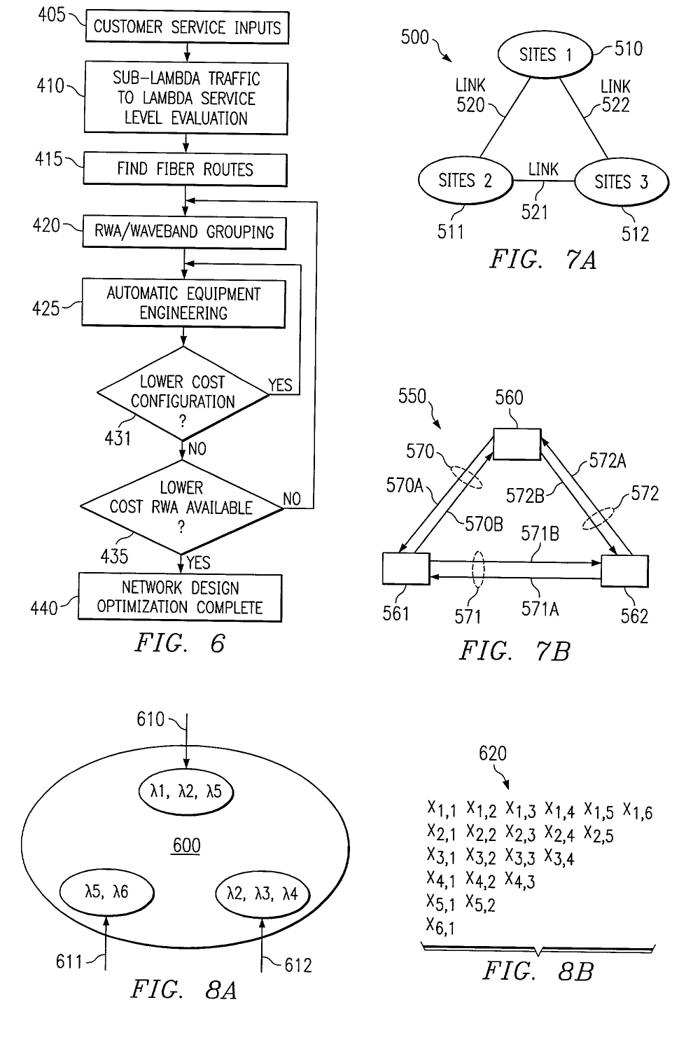

The present invention simulates various network configurations and analyzes associated costs thereof. To facilitate selection of an optimized network, requisite network performance specifications are processed and an optimized routing and wavelength assignment is determined. With reference now to FIG. 6, there is shown a flowchart depicting processing performed by algorithm 10 for determining RWA for an optimized network configuration. It is understood that the various method steps, of subsets thereof, illustrated in FIG. 6 may be performed by various subroutines of the main optimization algorithm 10 or may be representative of separate algorithms invoked by algorithm 10.

Optimization of a network design is initiated by input of customer network requirements (step 405), such as conveyance of inputs 20-22 to algorithm 10. As described hereinabove, inputs 20-22 specify the connection of network sites, traffic type (DS1, DS3, OC3, OC12), fiber quantities, protection requirements, and/or other attributes of a customer networking requirement. Thereafter, algorithm 10 analyzes customer traffic that may be input into physical layer 140 of the network and evaluates conversion of the subscriber traffic to lambda service level traffic (step 410), that is an evaluation of conversion of subscriber traffic (also referred to as sub-lambda traffic) received at a site 110-116 of physical layer 140 into an optical format suitable for transmission across physical layer 140 is made. Evaluation of sub-lambda traffic conversion to lambda service levels includes grouping traffic streams that share a common source and destination and is facilitated by input and analysis of network connectivity by algorithm 10. All sub-lambda traffic loads that have a common source and/or destination site may be mutually associated in a linked list data structure, or other suitable data format. Associated sub-lambda traffic loads may comprise a source/destination group. A source/destination group may be designated in a hierarchical manner and a head, or lead, group may thereby be designated. Channel grouping is then evaluated on each source/destination group of sub-lambda traffic and lambda channel groupings are thereafter generated.

Resource class and resource information input files are modifiable to include equipment class and model type of available equipment to facilitate evaluation of conversion of sub-lambda traffic to lambda service levels. Resource class and resource information data, such as performance parameters, is then input into an equipment matrix output file. Potential service equipment identified by algorithm 10 is associated with a particular network site.

Completion of evaluation of conversion of sub-lambda traffic to lambda service levels may result in algorithm 10 generating various outputs, such as a lambda service traffic output, sub-lambda post-grouping traffic, and site equipment outputs. Sub-lambda post-grouping traffic outputs may include lambda level traffic requirements. The site equipment output may contain a detailed listing of available site equipment entities, that is components, identified by algorithm 10. An equipment matrix may be generated that summarizes a site equipment entity count on a per site basis. To maximize utilization of the lambda channel, or wavelength, capacity, wavelengths may be shared among multiple sites. Ring routing allows for multiple add/drop sites for a single lambda. By efficiently packing traffic into the utilized wavelengths, the requisite service equipment and the number of wavelengths may be reduced. Lambda level community-of-interest (COI) requirements for sub-lambda service traffic may be added during sub-lambda traffic to lambda service level traffic conversion evaluation as well.

Potential fiber routes are next determined by algorithm 10 (step 415). For example, for an optical ring network conforming to physical layer 140, potential routes of the ring network are determined for the optimized lambda service level traffic evaluated in step 410. To facilitate identification of potential fiber routes, a directed graph data structure is created and associated with physical layer 140. The graph is composed of nodes and directed edges. Every node of the graph is associated with, and representative of, a site of the physical network. A directed edge originates from a node and terminates at an adjacent node to form a directed edge. Each directed edge of the graph is associated with, and representative of, a physical link, i.e. a fiber, of the physical network. Two opposing directed edges terminated by two adjacent nodes are representative of a bi-directional link, that is a fiber pair, connecting the two adjacent sites respectively represented by the two nodes. Thus, the node/edge representation comprises a logical representation of the fiber/site connectivity of physical layer 140. A shortest path may then be determined by evaluation of the graph. For example, an instance of the well-known Dijkstra's Algorithm may be invoked to search for the shortest path.

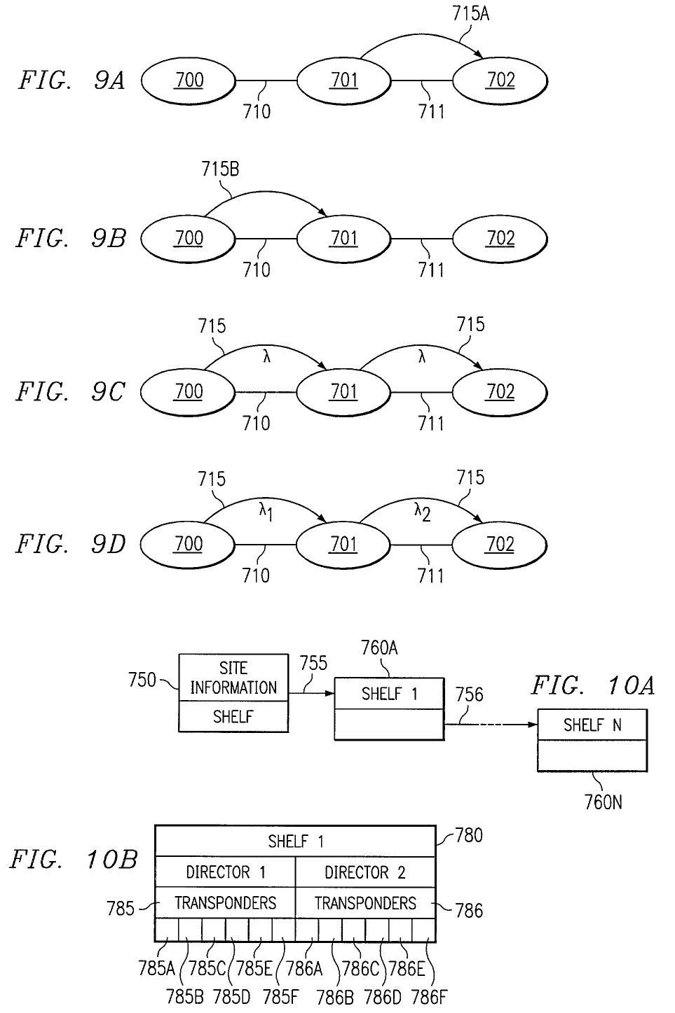

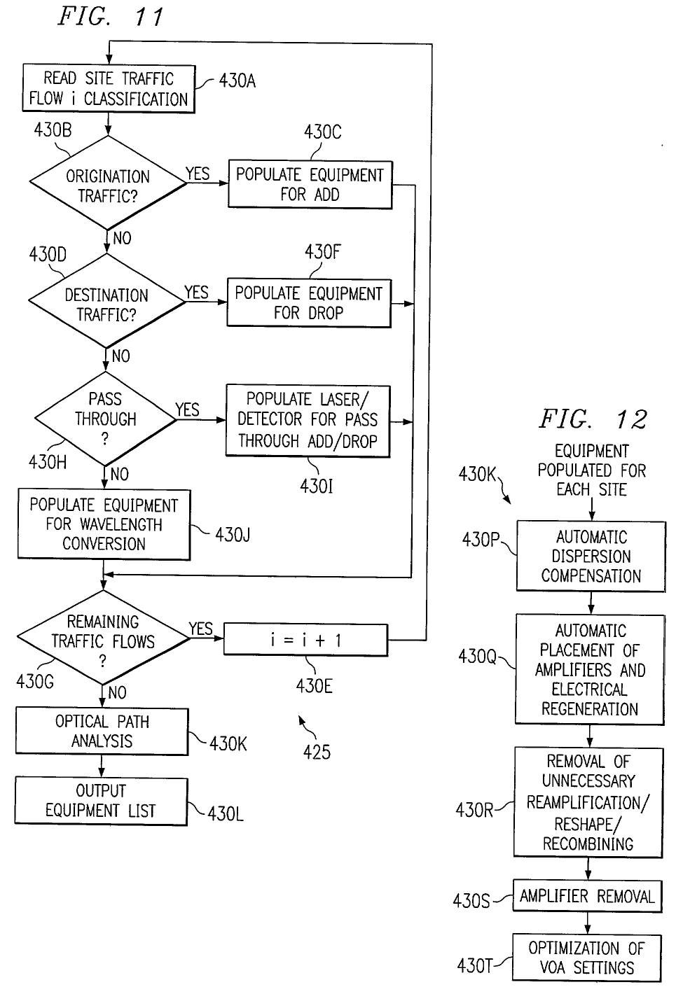

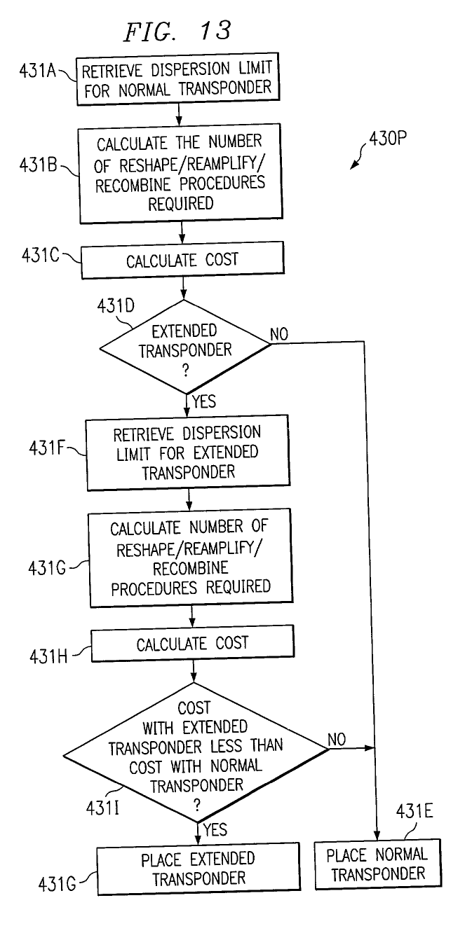

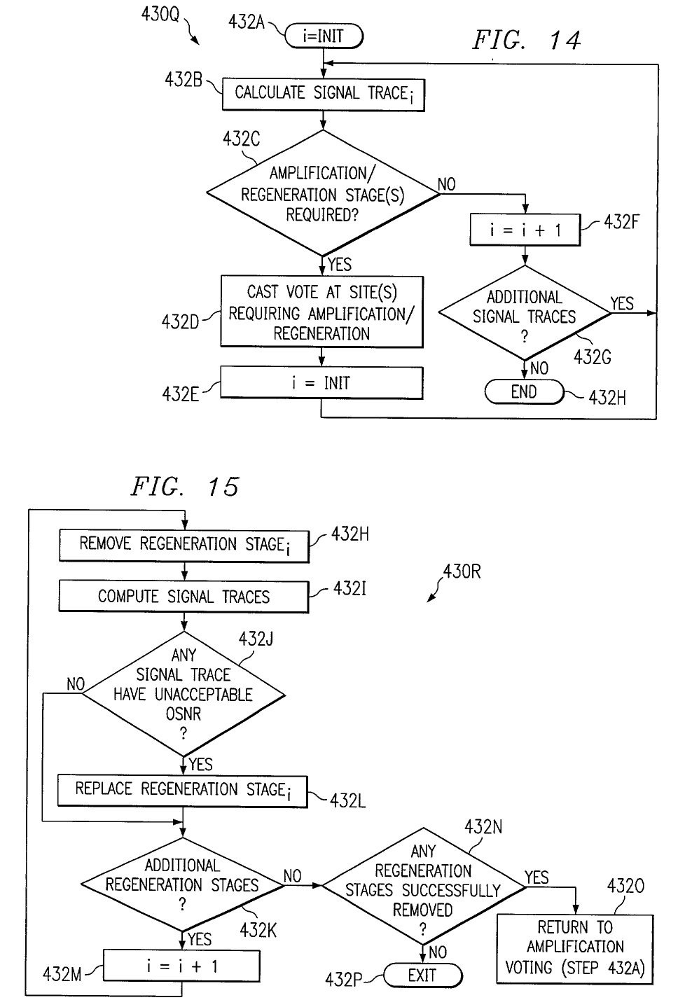

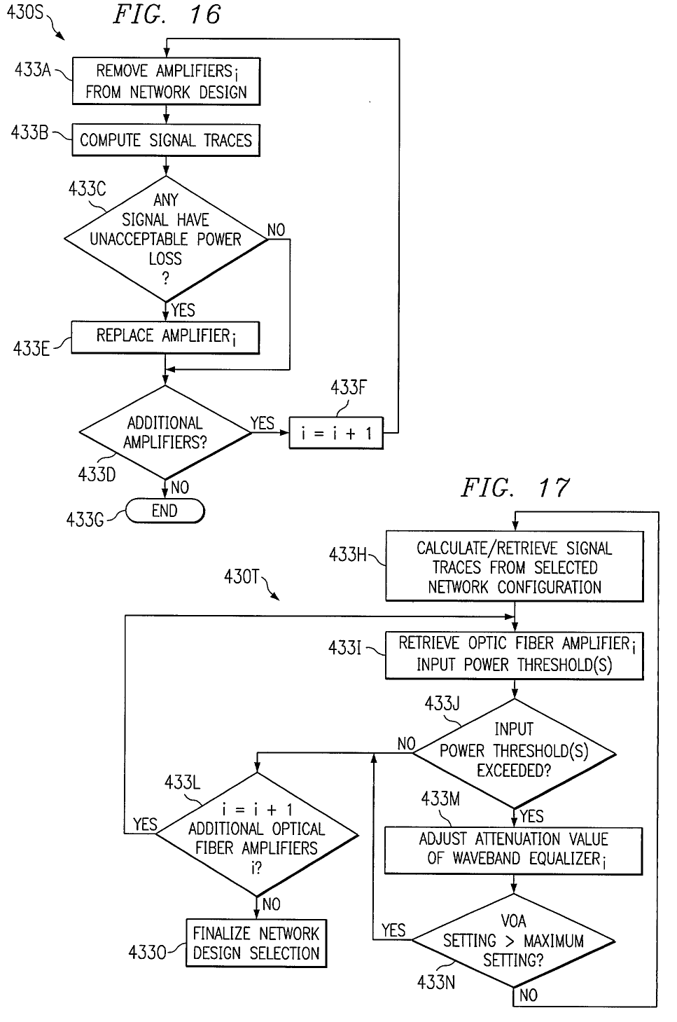

Identification of potential fiber routes may be better understood with reference to the simplified block diagram of FIG. 7A that illustrates the structure of an exemplary ring network 500. Network 500 comprises sites 510-512 interconnected by physical links 520-522. In the illustrative example, sites 510 and 511 are interconnected with physical link 520, sites 511 and 512 are interconnected with link 521, and sites 510 and 512 are interconnected with link 522. For simplification of illustration, each link 520-522 represents a bi-directional link and, accordingly, thus is representative of two fibers that are commonly terminated by two of sites 510-512. In FIG. 7B, there is illustrated a directed graph data structure 550 generated to logically represent network 500 and that may be stored on a computer-readable medium and processed by algorithm 10. Structure 550 comprises nodes 560-562 and directed edge pairs 570-572. Each node is representative of a site of the network. In the illustrative example, nodes 560-562 are representative of sites 510-512, respectively. Likewise, each directed edge pair 570-572 is representative of links 520-522, respectively. Each directed edge pair 570-572 respectively comprises two opposing directed edges 570A-570B-572A-572B. A directed edge, for example directed edge 570A, is representative of a physical, unidirectional link. Thus, a directed edge pair, for example directed edges 570A and 570B, is associated with and representative of a bi-directional physical link. In the illustrative example, directed edges 570A and 570B are associated with and representative of bi-directional fiber link 520, directed edges 571A and 571B are associated with and representative of bi-directional fiber link 521, and directed edges 572A and 572B are associated with and representative of bi-directional fiber link 522.

Notable route characteristics that may be considered when evaluating potential fiber routes include signal loss, diverse routing and shared path protection. Shared path protection prevents lambda traffic loads with common links from sharing the same protected route. Signal loss is used as a parameter for evaluation of a shortest path. Preferably, three aspects of signal loss over a link are taken into consideration: loss of fiber transmission, loss of FPP, and pass-through loss of optical wavelength filters. Total FPP loss represents the fiber patch panel connection loss along the signal path and may be modeled by:

Total FPP Loss=(Loss Per FPP*FFP per Site)*(x+1) eq. 2

where x=number of pass through sites. OMX losses may be modeled as:

OMX loss=A*y+B, y≠0 0, y=0 eq. 3

where y is the number of band shelves in series, A represents the pass through loss per OMX for a particular vendor, and B represents an OMX fiber connector loss for the particular vendor.

Accordingly, a composite signal loss may be determined by equation:

Min Signal Loss=ΣFibers+Total FPP Loss+ΣOMX loss eq. 4

where ΣFibers is the link loss in the fiber path. The minimum signal loss model may easily be modified to compensate for new optical components and/or new equipment vendors.

It should be understood that equation 4 is only an exemplary technique for modeling signal losses and other techniques may be employed by the invention. For example, in a preferred embodiment of the present invention attenuation losses imparted on an optical signal as it is passed through various components of the network design are modeled according to performance characteristics of the modeled component. Additionally, dispersion losses, for example polarization mode dispersion and chromatic dispersion, such as channel effects on individual light paths are modeled. It should be understood that any network component may effect the optical signal quality and may be modeled accordingly. Pursuant to providing a network design featuring the most economical infrastructure available, other network characteristics may be modeled and considered during network design. For example, component life expectancies may be modeled and estimated replacement costs may be considered when generating a network design.

For ring and mesh based networks featuring route protection, the network designer must allocate lambdas in multi-directional routes to deliver availability requirements by service providers. Prior to assignment of wavelengths, the shortest signal-loss routes available to deliver traffic from the source(s) to the desired destination(s) are computed to facilitate simplification of various subroutines of algorithm 10. Additionally, algorithm 10 may compute path reliability based on the reliability of individual components that the light signal passes through. Assignment of lambdas based on potential routes is described more fully hereinbelow.

Physical links interconnecting different sites may share one or more lambdas, that is a particular optical wavelength may be commonly transmitted over physical links interconnecting different sets of sites by a technique commonly referred to as wavelength reuse. Shared lambda routes are composed of several point-to-point routes that form a system ring. The shared wavelength routes may be found by decomposing the ring into individual point-to-point traffic that can be evaluated using Dijkstra's algorithm or another suitable algorithm.

Routing and wavelength assignments (RWA) and waveband grouping of lambda-level traffic may be performed after identification of potential fiber routes (step 420). The well-known Greedy algorithm, or another similar application, is invoked to determine an optimized traffic wavelength and routing assignments. Traffic may be assigned in descending order of total bandwidth consumed and traffic parameters used for evaluation of RWA and waveband grouping preferably include traffic demand and signal route loss. Parameters involved in RWA and waveband grouping may be weighted such that one parameter, for example a traffic demand parameter, has greater influence over another parameter in determination of appropriate RWA and waveband groups. For each traffic demand, several RWA computations are preferably made. A clear path is first considered for each wavelength assignment to facilitate minimization of OEO. If a clear path is unavailable, an unclear path is thereafter considered and a minimum converter algorithm is invoked to determine an optimized unclear path. Unassigned traffic will then be input in an unassigned queue. If the unassigned queue does not have capacity for any unassigned traffic, additional fiber and/or additional wavelength(s) will be required to support the network traffic demand.

RWAs are first attempted to be made on clear, that is continuous, path routes. If a clear path is unavailable, algorithm 10 then attempts to determine a suitable unclear path for the traffic. If both a clear path and unclear path are unable to be determined for a traffic demand, or a portion thereof, the well-known Ford-Fulkerson's method of maximum flow is invoked to assign wavelengths to the traffic without increasing the capacity of the network. Accordingly, OEO transponders are required. As mentioned hereinabove, an unclear path assignment comprises a path where a unique wavelength is not available on all the links throughout the path for delivery of a traffic load from the source to destination site. Therefore, different segments of the route will have different wavelengths assigned thereto and wavelength conversion is thus required. Algorithm 10 attempts to minimize wavelength conversions by selecting an available wavelength that traverses more links along the path than other available wavelengths. This process is iteratively repeated along all route segments until the destination node is reached and, accordingly, the complete route involves the minimum OEO conversions available.

A wavelength matrix may be defined that is accessible by algorithm 10 for facilitating allocation of lambdas. An exemplary wavelength matrix accessible by algorithm 10 is three-dimensional and may be represented as:

$$Λ \text{:} = ( \begin{matrix}{Λ}_{1} \\ • \\ {Λ}_{i} \\ • \\ {Λ}_{I}\end{matrix} ) \qquad eq . 5$$

where:

Λ_{i,j,k}=

1, if allocated

0, unallocated

i=wavelength;

j=identification of the traffic source; and

k=destination site for a particular traffic load.

The wavelength matrix is used to record global resource allocations for the wavelength assignments within the network. The wavelength matrix shown in equation 5 provides only a portion of a full wavelength matrix for simplification of description and due to symmetry of the wavelength matrix.

Inefficient waveband grouping may result in an undesirable increase of the total cost of infrastructure for a network design due to an increase in resource requirements, such as shelves, lasers and detectors. Algorithm 10 correlates wavelength add and drop procedures to wavelength banding to potentially reduce the requisite number of network equipment entities. A two-dimensional array may be defined that records the total number of times a potential lambda is dropped (or added) along with another lambda.

Algorithm 10 evaluates waveband grouping on a site-by-site basis. The procedure used by algorithm 10 for evaluating potential waveband groupings may better be understood with reference to the site schematic of FIG. 8A that shows a network site 600 terminating three incoming links 610-612 (fibers). In the illustrative example, link 610 is dropping wavelengths λ1, λ2, and λ5, link 611 is dropping wavelengths λ5 and λ6, and link 612 is dropping wavelengths λ2, λ3, and λ4. An array 620 for recording the count of add/drops of each lambda with another particular lambda has N-rows and columns, where N is the total number of lambdas in the current network design, as shown in FIG. 8B. A partial array 620 for a network including the exemplary node 600 will include six rows and six columns with scalar entries X_{i,j}, as well as rows and columns for any other wavelengths not terminated at the particular site shown in FIG. 8A. Each wavelength pair combination added or dropped at a common link has a corresponding entry in the array incremented. In the present example, wavelength pairs λ1 and λ2, λ1 and λ5, and λ2 and λ5 commonly dropped from link 610 have corresponding entries X_{1,2}, X_{1,5} and X_{2,5} of the array incremented. Likewise, wavelength pairs λ5 and λ6 commonly dropped from link 611 have entry X_{5,6} incremented and wavelength pairs λ2 and λ3, λ2 and λ4, and λ3 and λ4 commonly dropped from link 612 have corresponding entries X_{2,3}, X_{2,4} and X_{3,4} incremented. Algorithm 10 may then evaluate matrix 620 at each link and selection of wavelengths to be added or dropped may be facilitated by the add/drop counts maintained by array 620. Higher correlated wavelengths, that is wavelengths more often determined to be added and/or dropped together, are accordingly placed in a common band. Upon completion of waveband grouping, algorithm 10 may then generate more detailed network infrastructure information.

Returning again to FIG. 6, each site of the network design may now be populated with equipment, that is algorithm 10 may now consider the impact of various equipment types and vendors, that is various component models of equipment classes, on the overall performance and cost of the network design according to an automatic equipment engineering subroutine of algorithm 10 (step 425). The automatic equipment engineering subroutine includes an iterative process of populating each site of the network design with network components and analyzing optical characteristics of the resulting network configuration by a technique of calculating signal traces. As used herein, signal trace refers to a modeled optical signal having calculated attributes representative of various optical signal metrics, such as attenuation, noise, jitter, and/or other losses incurred during conveyance through a network and the various constituent components thereof. A calculated signal trace may include various attributes including power level, OSNR, chromatic dispersion level, polarization mode dispersion level, and/or crosstalk level as well as other signal attributes that each may be calculated at discrete positions within a network configuration along a defined optical light path, such as at the input and/or output of various network components positioned in the light path. As used herein, a light path is associated with a route and, in addition to identification of the source site, destination site, any intermediate site(s), and the fiber(s) through which the traffic demand is conveyed along the associated route, includes each individual network component through which the traffic demand passes (or is otherwise processed) during traversal of the traffic demand through the associated route. Thus, the signal trace is a logical representation of an optical signal and facilitates network design analysis of optical path characteristics, for example jitter, attenuation, dispersion, and/or other signal losses or distortion, that may be imparted on a signal as it is propagated through a network along a route from a source site to a destination site and through various network components therebetween. Each network component, for example fiber, amplifiers, multiplexers, splitters, etc., may effect one or more signal characteristics. The present invention generates a signal trace that preferably includes estimated signal mean and variances of an optical signal transmitted through the various network components. The impact of the signal losses on the overall network design is then analyzed (via analysis of the signal traces) prior to selection of a final configuration of the network design. Moreover, generation of signal traces for all required light paths facilitates an optimized and automated selection of amplifier and/or regeneration stage placement within the network design according to an embodiment of the present invention and as described more fully hereinbelow. The equipment population on each site will be based upon equipment constraints that may be taken from equipment vendor publications, laboratory analysis of equipment, and/or other information sources that provide operational characteristics of network components that may be included in the network design. Prior to this stage, only an approximation of signal loss is used to evaluate traffic routes based on approximations of equipment deployment.

The requisite equipment at a particular site is dependent on the traffic flow at the site. A traffic flow data structure is used to maintain a record of traffic flow(s) at each site of the network design. The traffic flow data structure may maintain individual traffic flows at each fiber of a site by a link-list or other suitable data structure. The traffic flow data structure specifies the source wavelength and fiber and the destination wavelength and fiber for each lambda-level traffic demand. In FIGS. 9A-9D, there is a simplified block diagram of four different traffic types that may be maintained by the traffic flow data structure for a site 701 of a network. Site 701 is interconnected by fiber links 710-711 with respective network sites 700 and 702. In FIGS. 9A-9D, traffic flows 715A-715D may originate, pass-through, or terminate at site 701. In FIG. 9A, site 701 is a traffic source and originates data traffic 715A that is directed to site 702 via link 711. In FIG. 9B, site 701 is a destination site and receives data traffic from site 700 via link 710. In FIG. 9C, site 701 is a pass-through site and conveys data traffic 715C received from site 700 via link 710 and passes the traffic 715C to site 702 via link 711. In FIG. 9D, site 701 conveys data traffic from site 700 to site 702 via links 710 and 711 and functions as a conversion node in which traffic 715D received from site 700 is subjected to wavelength conversion and thereafter passed to site 702 via link 711. Traffic originating from a source site and transferred to a destination site via an intermediate site therebetween is classified as pass-through traffic if the carrier wavelength is identical on both links. For example, traffic 715C is classified as pass-through traffic if wavelengths allocated on links 710 and 711 for passing traffic 715C are identical. Traffic originating from a source site and transferred to a destination site via an intermediate site is classified as wavelength converted traffic if the carrier wavelength of the traffic entering the intermediate site differs from the carrier wavelength exiting the intermediate site. For example, traffic 715D may be conveyed from site 700 to site 701 via link 710 on a first wavelength λ₁. Site 701 may then convert the traffic to a second wavelength λ₂ and transmit the traffic via λ₂ to site 702 over link 711. In such a scenario, traffic 715D is said to be wavelength converted and site 701 must have a wavelength converter therein to perform the channel conversion for passing traffic 715D from site 700 to site 702. Accordingly, algorithm 10 classifies inbound and outbound traffic at each site as source traffic, destination traffic, pass-through traffic, or conversion traffic.

Thereafter, automated equipment engineering is performed by algorithm 10 for the sites of the network design and an optical path analysis is performed to determine signal trace characteristics and amplification and/or regeneration stage placement as described more fully hereinbelow. For each source and destination site of the network design, transmission laser(s) and detector(s) are allocated to meet the add/drop traffic requirements. Thereafter, wave-band grouping is considered and may effect common equipment selection. A site information data structure contains logical association(s) with an equipment information data structure. Particular equipment entities may be constrained to have limited directionality, for example a laser transmitter may only be operational on outbound links from a network site. FIG. 10A is a block diagram of the logical relationship between a site information data structure 750 and one or more equipment data structures 760A-760N. Each site of the network design has a respective site information data structure 750 associated therewith. Each equipment shelf of each site, in turn, has a respective shelf entry 760A-760N in the equipment data structure that has a respective logical association 755 and 756 with site information data structure 750. FIG. 10B is a simplified block diagram of a shelf 780 that may comprise two banks 785 and 786 of directional transponders 785A-785F and 786A-786F and that may be logically represented by shelf data structure 760A. Each of transponders 785A-785F and 786A-786F may be responsible for generating a particular waveband. Generally, a waveband is associated with a direction (from one origination site to a destination site) and, accordingly, each transponder 785A-786F may be responsible for optic modulation of a waveband from one site to another. Accordingly, transponders 785A-786F are considered directional equipment.

Wave-band grouping of pass-through traffic at a site may be performed under one of two general scenarios: the waveband a wavelength belongs to is not an add/drop wavelength at the site or the wavelength belongs to a waveband that is add/dropped at the site. In the former case, no additional DWDM line card equipment is required, that is, no optical conditioning of the waveband is required to be performed by the site and the traffic is passed through the site as received. Accordingly, in such a scenario, no equipment population is needed for pass-through of the waveband. In the latter case, the waveband that the wavelength belongs to is added (or dropped) at the site of the network design. If the pass-through traffic is on a wavelength being dropped, the pass-through traffic is regenerated prior to being retransmitted from the site and two DWDM transmission transponders are required. One transmission transponder is needed to support wavelength conversion and an additional line card transponder is required to transmit the traffic to the destination subscriber tributary for the wavelength(s) carrying subscriber traffic that is dropped. Algorithm 10 optimizes wave-band grouping to minimize OEO equipment as discussed hereinabove. In this phase, all pass-through channels will be evaluated if the band is added or dropped at the site. Additional equipment will be populated if OEO is required.

A centralized equipment count for the network design is provided through the use of an equipment matrix E. The exemplary equipment matrix has a row dedicated to each site of the network design and each column thereof is assigned to resources of a site. Thus, a particular equipment entity may be indexed by indexing the row number that corresponds to the site and the column number that is associated with the particular site equipment. Additionally, each site has a list of shelves allocated to it. Traversal through the equipment matrix may be made such that each shelf of any network design site may be indexed and incremented as shelves are added to the network design. Each equipment matrix entry may maintain a count of transponders at each site as well and, accordingly, as transponders are added, the transponder count of a shelf may be incremented to indicate the overall shelf and transponder count of each site of the network design.

$$E \text{:} = ( \begin{matrix}{e}_{1 , 1} & • & • & • & {e}_{1 , N} \\ • & • & • & • & • \\ • & • & {e}_{r , n} & • & • \\ • & • & • & • & • \\ {e}_{R , 1} & • & • & • & {e}_{R , N}\end{matrix} )$$

Thus, the equipment matrix represents the number of components located throughout the network, where R represents the total number of components and the column index n represents the site index.

With reference again to FIG. 6, a cost evaluation of the network design configuration is next made (step 431). A cost evaluation will be made for the equipment required in all sites within the network design. Preferably, the cost evaluation is based on transmission costs within the network. A unit price matrix U is generated and represents the individual unit price cost for different components of the network design as defined by equation 6.

U:=(u₁·uᵣ·u_{R}) eq. 6

The r index is used to select a particular component unit (u), or equipment entity type such as a particular equipment component uniquely identifiable by a model identity of a component class, of the network design and u_{R} represents the total number of the component units within the network design.

A site cost matrix S may be defined that represents the total cost of a particular site of a network design and may be defined by equation 7:

Sᵢ:=U·E eq. 7

where i is an index to a particular site of the network design. Thus, the site cost matrix is a 1×N matrix where N is the total number of network design sites. The site cost matrix may be generated by multiplying the unit price matrix by the equipment matrix. Thus, a total equipment cost, C, may be computed by summing the individual entries of the site cost matrix.

$$C \text{:} = {\sum }_{n = 1}^{N} {S}_{n} \qquad eq . 8$$

As described, algorithm 10 generates a cost evaluation for the network design developed to satisfy a customer traffic requirement. An optical path analysis is then preferably performed as part of the automatic equipment engineering routine by calculating signal traces, or optical signal models, according to an embodiment of the invention and the steps of equipment provisioning and optical path analysis may be iteratively repeated until an optimized network design configuration providing the most beneficial light path characteristics is determined.

Performance characteristics of all available network components may be modeled and their respective impact on the overall network design performance and cost may be accounted for in the network design process by calculating each component's contribution to signal loss. Table D summarizes exemplary laser transmitter and detector characteristics that may be modeled on an individual component basis and used by algorithm 10 for calculating signal trace attributes, network infrastructure costs, and/or other parameters effecting the network design.

TABLE D

| Parameter | Value | Units |
|---|---|---|
| End of Life Power Out | Mean = −1.0, Std = 0.3 | dBm |
| Minimum Receiver Intensity | −20 | dBm |
| Receiver Overload | −10 | dBm |
| Receiver Dispersion Limit | 1200 | ps |
| Maximum Total System Penalty | 5 | dB |
| Receiver PMD Limit | 12 | ps |
| Launch OSNR | 60 | dB |
| Minimum OSNR @ Receiver | 24 | dB |

Each of the transmitter and receiver parameters summarized in TABLE D have exemplary parameter values assigned thereto that are device dependent, that is a plurality of transmitter and/or detectors may be available for placement in a design network and, preferably, each available transmitter and detector would have performance parameters individually defined therefor. Performance parameters of an individual component may be obtained from vendor specifications, testing, or other information sources.

As an optical signal is propagated through a fiber and subjected to optical conditioning, such as OEO regeneration, a variance, such as signal jitter, is imparted on the signal. The amount of jitter imparted on the optical signal may be a function of the number of regenerations to which the optical signal is subjected. Modeling of signal jitter may be a simple function of the quantity of the number of regeneration procedures and the amount of jitter introduced by each regeneration component. A discrete jitter power penalty may accordingly be introduced into a signal trace calculation by deducting a calculated decibel value from the signal trace power level at discrete locations within the network design. For example, a count of regeneration stages between a site from which the signal trace exits and another site subsequently entered by the signal trace be made and a jitter power penalty may be deducted from the calculated power level at the entry site prior to calculation of the signal trace power level, OSNR, or other characteristic, at any component locations within the site.

The bit error rate at a receiver is generally a result of the optical signal to noise ratio. Propagation of the optical signal through the fiber may contribute to the OSNR. Preferably, the OSNR contribution is modeled for any network component that contributes noise to the optical signal and is included in a signal trace model developed by algorithm 10 An OSNR penalty is then computed on a per component basis and introduced into the signal trace upon calculation of the signal trace at the respective component location.

Polarization mode dispersion of an optical signal is caused by non-symmetries in wave guides and is accumulated as the optical signal is propagated through the physical link and contributes to the overall distortion of the optical signal. Preferably, polarization mode penalties are applied at the receiver based on an estimated polarization accumulated during the modeled signal propagation through the link and may be subtracted from the signal trace power level at entry to a receiver. Thus, a PMD penalty may be introduced into the signal trace and may be function of a discrete fiber characteristic and a length of the fiber designated for implementation within the network design.

Optical signals are susceptible to chromatic dispersion, in addition to PMD, as a result of the particular fiber type utilized in a physical link and the length of the fiber. Accordingly, chromatic dispersion may be included within a signal trace and a chromatic dispersion power penalty may be levied at each receiver of the signal trace.

Coherent cross talk may be introduced into an optical signal at a multiplexer during performance of a drop procedure. A cross talk ratio may be estimated by computing a desired power of an optical signal exiting a network design site divided by a leakage signal from the dropped signal. The isolation loss combined with the band pass loss is used to compute the leak signal power at the interference point.

Signal filtering performed by OMXs during add and/or drop procedures may introduce various signal losses and may impart such losses on signal bands and to individually added and/or dropped wavelengths and may be included within a signal trace by introduction of an appropriate penalty. TABLE E summarizes various filter parameters that may be modeled and the effect thereof may be included in the calculation of one or more signal trace attributes. Particular values assigned to a filter parameter are filter dependent.

TABLE E

| Filter Parameters | Units |
|---|---|
| Band Pass through Loss (Mean and Signal Variance) | dB |
| Channel and Band Add Loss (Mean and Signal Variance | dB |
| per channel) | |
| Channel and Band Drop Loss (Mean and Signal Variance | dB |
| per channel) | |
| Isolation Loss (Mean and Signal Variance) | dB |
| PMD pass through | ps |
| PMD Add | ps |
| PMD Drop | ps |

Couplers and splitters may contribute to signal attenuation, PMD, and/or other signal degradations. TABLE F summarizes exemplary coupler and splitter parameters that may be included in calculation of a signal trace. The particular value assigned to a coupler or splitter is device dependent.

TABLE F

| Coupler and Splitter Performance Parameters | units |
|---|---|
| C Splitter and Equalizer Loss (Mean and Signal Variance) | dB |
| L Splitter and Equalizer Loss (Mean and Signal Variance) | dB |
| C Coupler Loss (Mean and Signal Variance) | dB |
| L Coupler Loss (Mean and Signal Variance) | dB |
| PMD Splitter | ps |
| PMD Coupler | ps |
| PMD C Band | ps |
| PMD L Band | ps |
| Number of C Band Variable Optical Attenuator | |
| Number of L Band Variable Optical Attenuator | |

Optical amplifiers may introduce noise, PMD, and/or other losses to an optical signal during amplification of the signal that may be modeled by a signal trace. Additionally, each available amplifier will have defined performance limits and/or tolerances, such as an operational bandwidth, a minimum and maximum signal input power, as well as other performance parameters. TABLE G summarize exemplary amplifier performance parameters that may be modeled by algorithm 10 and included within a calculated signal trace on a device-dependent basis.

TABLE G

| Amplifier Parameters | units |
|---|---|
| Optical Gain (Mean and Signal Variance) | dBm |
| Maximum Wavelength supported | nm |
| Minimum wavelength supported | nm |
| Maximum Transmission Power | dBm |
| Minimum Transmission Power | dBm |
| Maximum Receive Level | dBm |
| Minimum Receive Level | dBm |
| Receiver Overload | dBm |
| Maximum Cascade Number of amplifiers | |
| PMD pass through | ps |
| Noise Figure | dB |

A better understanding of light path analysis and equipment provisioning of the network design as performed by an embodiment of the present invention may be had with reference to the equipment provisioning flowchart of FIG. 11 that shows, in part, a simplified processing of the automatic equipment engineering routine (step 425 of FIG. 6). As described hereinabove, traffic at each site is classified as origination, pass-through, wave-converted or destination and, accordingly, the requisite equipment at the particular site for processing the traffic may be defined by the traffic classification.

Equipment provisioning commences by reading a traffic flowᵢ classification (step 430A) and determining whether the traffic flowᵢ is classified as origination traffic (step 430B). An affirmative evaluation thereof results in population of site equipment requisite for processing origination traffic (step 430C). Algorithm 10 processing may then evaluate whether additional traffic flows remain for additional equipment population (step 430D). A determination of additional traffic flows may result in incrementing a counter i (step 430E), or performing another process that facilitates reading of the additional traffic flow classification, and returning algorithm 10 processing to step 430A. If traffic flowᵢ however, is not determined to be classified as origination traffic, algorithm 10 may next evaluate traffic flowᵢ to determine if the traffic flow is classified as destination traffic (step 430D). An affirmative evaluation of traffic flowᵢ as destination traffic results in equipment population of the site for performing a drop (step 430F) procedure and processing may proceed to evaluation of additional traffic flows (step 430D). Failure to identify traffic flowᵢ as either an origination or destination traffic flow results in next evaluating the traffic load as pass-through classified traffic (step 430H). Confirmation of classification of traffic flowᵢ as pass-through traffic results in requisite equipment population of a laser transmitter, a detector, and/or equipment for performing add/drop procedures of the traffic flow, as need be (step 4301) for populating the site such that it is operable as a pass-through site and thereafter algorithm 10 may proceed to evaluate whether additional traffic flows exist for the site (step 430D). Failure to identify the traffic flowᵢ as pass-through traffic results in the identification of the traffic as wavelength converted traffic and, accordingly, site equipment is populated therefor (step 430J). Thereafter, algorithm 10 may proceed to evaluate whether additional traffic flows exist for the site (step 430D). Upon equipment population for all traffic flows at all network design sites, algorithm 10 may proceed to perform an automated link engineering routine (also referred to as an optical path analysis) (step 430K) and subsequently output an equipment list for the site of all equipment components added during each iteration of the processing flow described (step 430L).

The automatic link engineering procedure involves modeling light path characteristics, that is generating signal traces, of the network design and automatically disposing network components, such as optical amplifiers, regeneration components, or other devices, within the network design to compensate for optical signal deterioration according to an embodiment of the invention. Pursuant to reducing the overall network design cost, the automatic link engineering procedure utilizes a cost analysis to select the most economical network solution that satisfies the network performance requirement, that is the overall subscriber traffic and performance demands. As components are added and/or removed from the network design, all of the network design wavelengths must be re-evaluated for network propagation and deterioration characteristics to ensure appropriate signal levels are present at all network receivers.

With reference now to FIG. 12, there is shown a flow chart depicting the automatic link engineering procedure (step 430K) of FIG. 11. The automatic link engineering procedure is initiated by reading the equipment population of each network design site by an automatic dispersion compensation routine (step 430P) that may compensate for dispersion losses by designating placement of one or more regeneration and/or dispersion compensation modules within the network design. Thereafter, automated placement of amplification and/or regeneration stages may be performed by sequentially developing signal traces and determining locations within the network having unsuitable signal attenuation and/or distortion (step 430Q). Each regeneration stage may then be evaluated for necessity of inclusion within the network design by sequentially designating each regeneration stage for removal from the network design, recalculating signal traces, and analyzing resulting signal trace attributes (such as PMD, chromatic dispersion, jitter, or other calculated distortion attributes) for evaluation of unacceptable distortion (step 430R). Likewise, amplification stages may be sequentially designated for removal and modeled signal levels may be recalculated and analyzed to determine whether any signal levels have unacceptable attenuation as a result of removal of a the amplification stages (step 430S). Additionally, optimization of optical attenuation may be performed to ensure that optical signal power levels at any amplification stage inputs do not exceed the input power ratings of the amplification stages (step 430T).

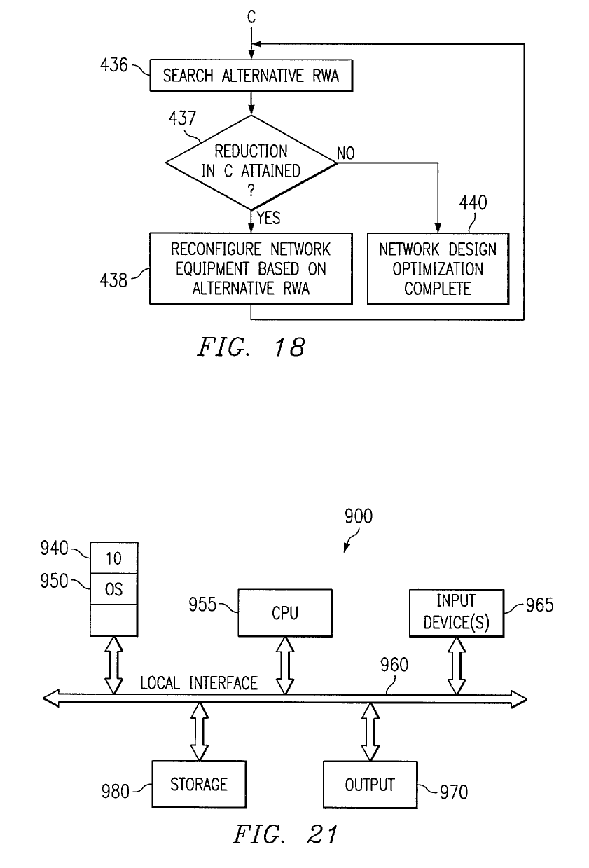

With reference now to step 430K of FIG. 12, the automatic dispersion compensation routine models the accumulation of polarization mode dispersion and chromatic dispersion due to channel effects along individual light paths. An analysis of the modeled dispersion level against a maximum allowed dispersion level is made. If a signal trace is determined to have a dispersion level in excess of a maximum dispersion allowed, a regeneration stage and/or a dispersion compensation module may be selected for placement within the network design. As is known in the art, a regeneration component may comprise an OEO component that performs optical-to-electrical-to-optical signal conversion such that the signal, when converted to the electrical state, may be retimed, reshaped, and reamplified so that the signal, when converted back to the optical state, is suitably conditioned for conveyance in the network. A regeneration stage comprised of a dispersion compensation module, on the other hand, performs optical conditioning entirely in the optical domain. Selection of an OEO regeneration component may be made between a normal or extended regeneration transponder. In some network scenarios, dispersion compensation modules may not be a practical solution for optical signal conditioning and only regeneration stages may be selected for remedying unacceptable signal dispersion. The automatic link engineering algorithm calculates a cost of different dispersion compensation systems and automatically selects the components(s) that suitably compensate for the dispersion effects at the most economical cost. In addition to dispersion losses accumulated on the optical links, signal and OSNR losses are also modeled as the wavelength passes through filters, links, couplers, splitters, and connectors. The automatic link engineering procedure models these losses to determine their effect on requisite signal amplification and electrical regeneration as described more fully hereinbelow with reference to FIG. 14.

In the event a dispersion compensation module may not be implemented within the network design, a process for selection between a normal transponder and an extended transponder may be performed as described with reference to FIG. 13 that shows a flowchart for an automatic dispersion compensation routine performed in accordance with step 430P of FIG. 12. The dispersion compensation routine is initiated by retrieving a dispersion limit for a normal transponder (step 431A). Thereafter, the number of retime/reshape/reamplify procedures required to compensate for signal dispersion is calculated based on the normal transponder performance characteristics and the resulting signal trace dispersion level (step 431B) and a cost of dispersion compensation is thereafter calculated (step 431C). An evaluation of whether an extended transponder may be disposed within the network where dispersion compensation is required is next made (step 431D). If placement of an extended transponder is not available, the normal transponder is selected and disposed within the network design (step 431E). If, however, an extended transponder may be disposed within the network design, retrieval of the dispersion limit of the available extended transponder is made (step 431F) and the number of retime/reamplify/reshape procedures is determined (step 431G). Thereafter, a cost of dispersion compensation utilizing the extended transponder is made (step 431H) and a comparison is made with the cost determined for implementation of a normal transponder (step 431I). Placement of the extended transponder within the network design is made if it is determined that signal compensation using the extended transponder is more economical than using normal transponders (step 431G). Otherwise, the normal transponder is selected for placement in the network design (step 431E).

A signal originating from a site is generated from a transmitter disposed within the site and has a particular power level provided to the signal dependent on the output power of the laser transmitter. The signal may pass through any number of sites, components in the various sites, and fiber(s) interconnecting any sites between the origination and destination site as the signal is conveyed through the network towards a destination site. The signal may be attenuated during the conveyance process by any of the components and/or fibers through which it passes. For example, the signal may be passed through a splitter at a site that has to drop another wavelength in a common band with the signal. Often times, a signal will pass through an amplification stage in series with a splitter. Both the amplification component and the splitter component can attenuate the signal, as well other components through which the signal passes, such as combiners, physical links, etc. If the attenuation imparted on the signal is sufficient to drop the power level of the signal below the sensitivity of the receiver at the destination site or any intermediate site(s), an amplification stage must be disposed within the network. The present invention models attenuation characteristics of each network component that may be included in the network design and thereby generates signal traces that have calculated attributes representative of a signal loss of a respective signal throughout its light path from an origination to a destination site. Accordingly, stages requiring signal amplification may be determined by algorithm 10. If it is determined that a signal attenuation is sufficient to decrease the power of a signal below the sensitivity of a receiver within the light path of the signal, an amplification stage is designated to be positioned at an exit of the last site where the signal power is sufficient for accurate reading of the signal. For example, if a signal that is generated at an origination site passes through an intermediate site prior to reaching a destination site, a signal trace may be generated that approximates the attenuation of the signal as it leaves the origination site, transfers over the link interconnecting the origination and the intermediate site, and includes any attenuation imparted on the signal while passing through the intermediate site and the final link interconnecting the intermediate site with the destination site. At any point along the light path that attenuation is sufficient to reduce the signal power below a sensitivity of a receiver at any site within the light path, an amplification stage is designated to be placed at the exit of the previous site. For example, if the signal trace indicates that the signal is sufficiently powered to be suitably read by a receiver at the intermediate site but insufficient to be read by the receiver at the destination site, an amplification stage is designated to be positioned at the exit of the intermediate stage in order to provide sufficient power for the signal to be read by the receiver at the destination site. This process is repeated for each required signal along the associated light path of the signal in the network design. Designation of placement of an amplification stage is herein referred to as amplification ‘voting’ and defines an amplification stage location, such as a site, and may include a directional designation (such as ‘entry’ or ‘exit’) of the amplification vote.

In addition to attenuation of the optical signal, a noise attribute such as an OSNR, as well as other distortion attributes, e.g. jitter, PMD, chromatic dispersion, etc., may be introduced by various network components and may be modeled as described hereinabove. Each receiver has an OSNR limit that, if not met by the optical signal, may result in an inaccurate or missed reading by the receiver. Similar to tracing of the attenuation of a modeled signal along a light path, OSNR and other signal trace attributes representative of various signal distortions may be traced as well. If a calculated OSNR is greater than a minimum OSNR limit at a detector, a vote for an electrical regeneration stage is placed at the previous site that may have a regeneration stage placed therein. Thereafter, the voting process is reinitialized and reexecuted.

Evaluation of an unacceptable signal distortion attribute or power level may be made at a site entry and/or a site exit depending on the traffic scenario being evaluated. For example, if it is determined that a signal trace has a sufficient power level at an input of a particular site, the signal trace may then be calculated through additional components at the site, such as filters or other components. The signal may be subjected to regeneration at the site and, accordingly, a receive sensitivity thereof may be evaluated. A signal trace determined to have an insufficient signal power level will result in a vote for an amplifier stage at the current site and, accordingly, an amplification stage vote is designated for the site. Likewise, power levels of the signal trace may be evaluated at a site exit and votes may be cast for a site on either (or both) a site entry or site exit. Each wavelength is limited to a maximum of one vote per direction. If multiple votes are cast for an amplification stage and/or a regeneration stage, an amplification and/or regeneration stage vote is placed at the first location receiving the vote during signal trace calculation. Signal traces are then recalculated and this procedure continues until no additional votes are placed for amplifiers and/or regeneration stages.

In FIG. 14, there is shown a flowchart depicting a subroutine performed by the automatic link engineering routine according to a technique that facilities automated placement of amplification and/or regeneration stages within the network design in accordance with step 430Q of FIG. 12. Prior to execution of the amplification/regeneration site selection routine, all possible light paths through which a signal trace may be calculated are defined within a temporary array, or another data structure. Preferably, each light path definition includes network component identifiers included within the light path definition, or another logical link thereto, such that a particular light path may be indexed and corresponding component performance parameters of network components included within the light path of the signal trace may be conveyed to the amplification/regeneration subroutine for calculation of a signal trace. An index may first be initialized (step 432A) and calculation of a signal traceᵢ is then performed (step 432B). Evaluation of the signal traceᵢ is then made to determine if the current network design configuration requires addition of any amplification and/or regeneration stage(s) (step 342C). Evaluation of a required amplification stage may be made, for example, by comparing the signal power input requirement of each component included within the light path of the calculated signal traces with the calculated signal trace power level at the input of the respective network component. Similarly, evaluation of a requirement for a regeneration stage may be made, for example, by comparing an OSNR input threshold (and/or another input signal distortion limit) of each component included within the light path of the calculated signal trace with the calculated signal trace OSNR (or another distortion attribute) at the input of the network component. If amplification and/or regeneration stage(s) are required, amplification and/or regeneration stage(s) are accordingly designated at a determined position(s) within the network design where placement of such a stage would compensate for unacceptable signal attenuation and/or distortion by placing an amplifier and/or regeneration vote at the determined position (step 432D). For example, if a signal traceᵢ power level is calculated to be below an input requirement of an OMX 163 of a transit site 160 included in the light path of the signal traces, an amplification vote may be designated at the input of transit site 160. Similarly, if an OSNR of a signal trace is calculated to be insufficient for the input of an FPP 181 of a destination site 180, a regeneration component may be designated for placement at the exit of the previous site in the light path of the calculated signal tracei by placing a regeneration vote at the exit of the previous site within the light path. It should be understood that amplification and regeneration stage ‘voting’ is a technique for accumulating a count of required amplification and regeneration stages (and a corresponding location thereof) within the current network design and recordation of amplification and regeneration votes may be made in an array or another suitable data structure. Upon designation of placement of one or more amplification and/or regeneration stages within the network design, the signal trace index is re-initialized (step 432E) and processing is returned to calculating of signal tracei. Reinitialization of looping through the amplification and regeneration placement subroutine is performed as a consequence that placement of an amplification or regeneration stage may effect previously considered signal traces. Signal traces calculated subsequent to designation of placement of an amplification and/or regeneration stage at step 432D are made with the amplification and/or regeneration stage designated for inclusion within the network design. That is, a signal trace calculated after voting for an amplification and/or regeneration stage will include the effects of the designated amplification and/or regeneration stage if the designated amplification and/or regeneration stage is within the light path of the subsequently calculated signal trace. An evaluation that no amplification or regeneration stages are required for the signal traceᵢ results in incrementing of the signal trace index (step 432F) and subsequent evaluation of whether additional signal traces remain for analysis (step 432 G). If an additional signal trace remains to be evaluated, processing may return to calculation of the next signal traceᵢ. The amplification and regeneration vote casting and positioning routine may exit upon an evaluation that no additional signal traces remain for evaluation (step 432H). The amplification and regeneration placement routine described is preferably executed in a forward and reverse light path traversal for all signal traces and amplification and regeneration stages may be designated for placement in a forward and/or reverse direction. It should be understood that amplification voting and regeneration voting, as described with reference to FIG. 14, may be performed sequentially or in parallel. Moreover, the automatic dispersion compensation routine may be performed as a subroutine of the regeneration voting procedure, that is the regeneration voting routine may include regeneration voting for placement of OEO and/or DCM regeneration components.

After placement of any amplification and/or regeneration stages within the network design, an evaluation may then be made to determine if unnecessary regeneration and/or amplification stages exist that may be removed from the network design without adversely effecting the network performance. Electrical regeneration stages may first be designated for removal. After designation of a regeneration stage for removal, signal traces are recalculated to determine if additional amplification stage(s) are required as a result of removal of the regeneration stage.

With reference now to FIG. 15, there is shown a flowchart depicting evaluation of removal of regeneration stages within the network design according to an embodiment of the present invention in accordance with step 430R of FIG. 12. Each regeneration stage of the network design is individually evaluated for removal from the network design and evaluation is initiated by designation of a first regeneration stagei for removal (step 432H). All signal traces are then re-calculated for the network design excluding the designated regeneration stageᵢ (step 432I) and each recalculated signal trace is evaluated for an unacceptable OSNR (step 432J) or other distortion attributes. If it is determined that no recalculated signal traces have an unacceptable OSNR or other unacceptable distortion attribute, the regeneration stageᵢ is permanently removed from the network design and processing continues by evaluating whether additional regeneration stages may be removed from the network design (step 432K). If, however, it is determined that any of the recalculated signal traces have an unacceptable distortion attribute after removal of the designated regeneration stage, designation for removal of the regeneration stageᵢ is withdrawn and the regeneration stageᵢ remains in the network design (step 432L). An evaluation of additional regeneration stages is then made (step 432K). If additional regeneration stages exist, a next regeneration stage may be designated for removal (step 432M) and processing may return to step 432H. Upon completion of evaluation of all regeneration stages for removal, it may be evaluated whether any regeneration stages were successfully removed from the network design (step 432N), that is whether any regeneration stages were removed without introducing unacceptable distortion attribute values of any signal traces. Removal of regeneration stage(s) from the network design may adversely effect power levels and, accordingly, if any regeneration stages are successfully removed, algorithm 10 may loop back to the amplification voting routine and evaluate signal traces for requisite amplification stages (step 432O) as aforedescribed with reference to FIG. 14. However, if no regeneration stages were successfully removed from the network design, the regeneration removal analysis may exit (step 432P).

Necessity of amplification stages placed in the network design during the amplification voting and placement routine is next evaluated. Each amplifier is designated for removal from the network design and all signal traces are recalculated and re-evaluated for signal quality. Re-evaluation of the signal traces is performed by re-tracing the signal through appropriate light paths in the network design having the designated amplification stage removed therefrom. If the re-traced signals are determined to have sufficient power levels, the amplification stage designated for removal may then be removed from the network design. Alternatively, if any signal traces have calculated attributes indicating insufficient signal levels at any location in the network, the designation for removal of the amplification stage is withdrawn and the amplification stage remains in the network design.

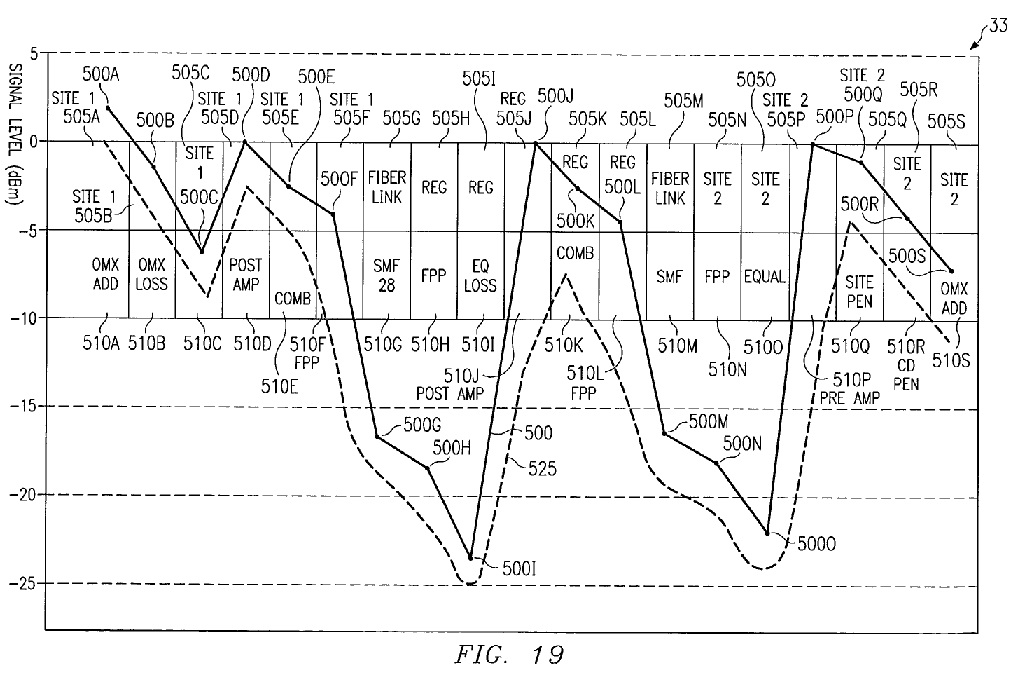

With reference now to FIG. 16, there is shown a flowchart depicting evaluation of removal of amplification stages within the network design in accordance with step 430S of FIG. 12. Each amplifier stage is individually evaluated for removal from the network design and evaluation is initiated by selection of a first amplifierᵢ for removal (step 433A). All signal traces are then recalculated for the network design excluding the designated amplifierᵢ (step 433B) and each recalculated signal trace is evaluated for an unacceptable attenuation (step 433C). If it is determined that no recalculated signal traces suffer an unacceptable power loss, the amplifierᵢ is permanently removed from the network design and processing continues by evaluating whether additional amplification stages may be removed from the network design (step 433D). If, however, it is determined that any of the recalculated signal traces have insufficient power levels after removal of the designated amplification stage, the designation for removal of the amplifierᵢ is withdrawn and the amplifierᵢ remains in the network design (step 433E). An evaluation of additional amplifier stages is next made (step 433D). If additional amplifier stages exist, a next amplifier stage may be designated for removal (step 433F) and processing may return to step 433A. The amplification removal routine may exit upon evaluation of all designated amplification stages (step 433G).

With reference now to FIG. 17, there is shown an optional variable optical amplification (VOA) subroutine that may be invoked by algorithm 10 to insure that maximum input power thresholds of any optical fiber amplifiers disposed within the network design are not exceeded in accordance with step 430T of FIG. 12. Modern optic networks may include one or more power band equalizers comprised of variable optical attenuators configured in a pre-amplifier stage such that optical signals are equalized across the wavelengths input into an optical fiber amplifier. Implementation of the VOA subroutine provides a technique ensuring, during network design, the highest possible signal level and OSNR are input into amplification stages without exceeding the input tolerances of the amplification stages according to an embodiment of the present invention. The VOA subroutine is initiated by calculating (or retrieving) signal traces from a network configuration previously selected (step 433H). The VOA subroutine is preferably executed subsequent to selection of a network configuration upon completion of evaluation of removal of amplification stages as described hereinabove with reference to step 430S as described with reference to FIG. 16. Maximum input power tolerance(s) are next retrieved for the optic fiber amplifierᵢ designated for placement in the selected network configuration (step 433I). Thereafter, an analysis of all signal traces having the optic fiber amplifierᵢ included within their respective light path are analyzed to determine if the signal level of any signal traces exceed the input tolerance of the optic fiber amplifieri (step 433J). If no signal traces are determined to have signal levels in excess of the input of the optic fiber amplifierᵢ, an evaluation of whether additional optic fiber amplifiers are designated for placement within the network design is made (step 433L). Processing may return to retrieval of the input power tolerance of optic fiber amplifierᵢ if any optic fiber amplifier stages remain. Otherwise, the network design may be finalized (step 4330). If, however, it is determined at step 433J that an input power tolerance of the optic fiber amplifierᵢ is exceeded, an attenuation setting of a power band equalizerᵢ disposed as a pre-amplification stage of optic fiber amplifierᵢ may be adjusted (step 433M) and an analysis of whether the increment to the power band equalizerᵢ exceeds operational capabilities thereof is made (step 433N). If the adjusted attenuation setting of the power band equalizerᵢ is within the operational range of the equalizer, processing may return to step 433H and signal traces may be re-calculated for the network design. The amount of adjust made to the attenuation level of the equalizerᵢ may be dependent on the particular wavelength being attenuated. Other techniques for adjusting the attenuation level of the equalizer are possible. Processing may return to evaluation of additional optic fiber amplifiers if the operation limits of the power band equalizer are exceeded (step 433L).

Returning again to FIG. 6, algorithm 10 evaluates whether a lower cost routing and wavelength assignment is available after iteratively performing the described automatic equipment engineering subroutine, that is algorithm 10 evaluates whether a lower cost network design may be developed by varying the RWA (step 435). Various techniques may be employed to evaluate the impact of alternative RWA assignments on the network design cost. For example, algorithm 10 may employ a conjugate gradient algorithm to search for a wavelength route reassignment that will yield a reduction in the cost of the network design. Such a process may be performed iteratively until no additional cost reduction is attained or may alternatively be iteratively performed a pre-defined number of repetitions. Other techniques may be substituted for a conjugate gradient algorithm technique of RWA reassignments, such as simulated annealing, neural network algorithms, and/or other techniques.

In FIG. 18, there is a simplified flowchart of algorithm 10 processing that may be performed to evaluate RWA reassignment and the effect on the overall cost of the network design. The total equipment cost determined from the equipment selection made after iteratively performing equipment provisioning and optical path analysis may be input into the conjugate gradient algorithm and alternative RWAs may be generated and associated cost (C) values determined therefor (step 436). A comparison between the total equipment cost for each alternative RWA may be compared with the total equipment cost of the current network design and an evaluation of whether a reduction in the network cost is made (step 437). If a reduction in the network cost is achieved by an alternative RWA, the network equipment provisioned for the network design is reconfigured according to the alternative RWA (step 438). For example, the site information data structures may be re-generated or modified, the site cost matrix may be updated, and/or other data structures may be modified, re-generated, or otherwise altered to reflect a modification to the network design required to achieve the alternative RWA. Algorithm 10 processing may then return to the iterative automatic equipment engineering subroutine and, thereafter, return to performing additional RWA iterations until a reduction in the network cost is not attained. Thereafter, algorithm 10 processing may terminate (step 440). In an alternative technique, traffic demands may be reiteratively assigned to various wavebands, rather than wavelengths, and the impact of network performance and cost may be similarly determined.

With reference now to FIG. 19, there is shown an exemplary signal trace 33 that may be output by algorithm 10 that graphically illustrates a modeled signal for a particular network configuration having equipment components designated for placement in each site of the network design. The exemplary signal trace 33 comprises a signal plot 500 and may comprise various site and/or component identifiers 505A-505S that are associated with particular plot points 500A-500S. The exemplary signal trace 33 illustrates a modeled signal for a wavelength being added at a site 1 identified by component identifier 505A. A signal modeled by signal trace 33 is then passed through a post amplifier, a combiner and an FPP prior to being conveyed across a first fiber link and conveyed to another FPP of a regeneration component. Thereafter, the modeled signal is passed through an equalizer, an amplification and a post-amplification stage, a combiner and an FPP before being conveyed on a second fiber link and transmitted to a second site.

Each particular plot point 500A-500S has a calculated signal level associated therewith. In the exemplary signal trace 33, plot points 500A-500S are plotted with respect to a signal value in decibels milli-Watts (dBm). Each component identifier 505A-505S may have a respective loss or gain identifier 510A-510S that provides a description of a respective signal loss or gain associated with a signal plot point 500A-500S. The exemplary signal trace 33 provides signal plot points for a modeled signal conveyed through various components of a first site (points 500A-500F), through a fiber link (point 500G), through a regeneration component (points 500H-500L), through another interconnecting fiber link (point 500M), and through various components of a second site (points 500 N-500S). As shown, the signal trace preferably includes calculation of an attenuation or gain incurred through various signal ‘penalties’ applied to the calculated signal level attribute of signal trace 33.

As aforedescribed, signal trace 33 may have one or more attributes, such as a power level attribute and any one or more of various distortion attributes, calculated at discrete locations (such as inputs and/or outputs of network components) of the network design. In a preferred embodiment, each of the power level attributes and the distortion attribute(s) have a mean and variance value calculated at each location for which signal trace 33 plot points are calculated. Thus, plot 500 may represent a mean power level calculated for signal trace 33. The mean of a calculated signal trace attribute is preferably calculated by employing statistical techniques and incorporates component performance variances in developing a power level attribute distribution. For example, each of plot points 500A-500S may be calculated as Gaussian distribution functions. Because component performance characteristics are statistically independent, the variances and/or means thereof may be summed (for gains), or alternatively subtracted (for losses), from point-to-point to determine variances and/or means of a particular plot point 500A-500S of signal trace 33. For example, to determine the mean power level of the combiner (identifier 505K), that is to determine the value of signal trace point 500K, the mean power level of point 500J (corresponding to the mean power level at a post amplification stage designated by identifier 505J) is summed with the mean loss of the combiner stage corresponding to point 500K. While the signal trace 33 is representative of a signal trace power attribute, a similar signal trace may be developed for any distortion attributes, such as jitter, crosstalk, PMD, chromatic dispersion, or another distortion attribute, for which associated component performance parameters are known or otherwise obtainable. Preferably, signal trace(s) generated for distortion attributes are likewise generated as mean distortion values.

In addition to plot 500 of a signal trace attribute, a graphical output may include a plot 525 (illustratively denoted with dashed lines) of a network design criteria. Plot 525 may be generated by plotting input requirements of each network component included in the network design. Thus, by calculating the signal variance of any signal trace 33 plot point, a probability of satisfactory network design performance at that network position may be had. Advantageously, statistical design points may be defined prior to network design such that a network design is generated that provides a desired statistical performance. For example, a statistical design point of plot 525 may be defined for an optical path that may be disposed within a network to be designed such that the optical characteristics of a generated network design will meet the statistical design criteria. Thus, the network designer can specify a numerical probability of proper operation of an optical path that is desired and algorithm 10 is constrained thereby such that any selected network configuration will meet, or exceed, the statistical design criteria for the optical system. Specification of a statistical design point for a particular component may be defined by equation 9.

SDP=Signal_Mean(Component)−Std_Dev*Sqrt(σ²) eq. 9

where SDP is the statistical design point and σ² is the variance.

As mentioned hereinabove, algorithm 10 may provide various outputs to an operator thereof. For example, an optimized network map 30 detailing network design sites, network components selected for population of various network sites, and graphical indications of RWAs may be visually summarized in a visual output. Other outputs, such as network layer specifications 31 detailing network site and connectivities therebetween, listings of equipment 32 selected for deployment within the selected network design, as well as visual output of signal trace(s) 33. Algorithm 10 may provide various other outputs as well. For example, cost optimization bar graphs may be generated by algorithm 10 that provide an effective and intuitive demonstration of network cost savings obtained through analysis of various network design configurations.

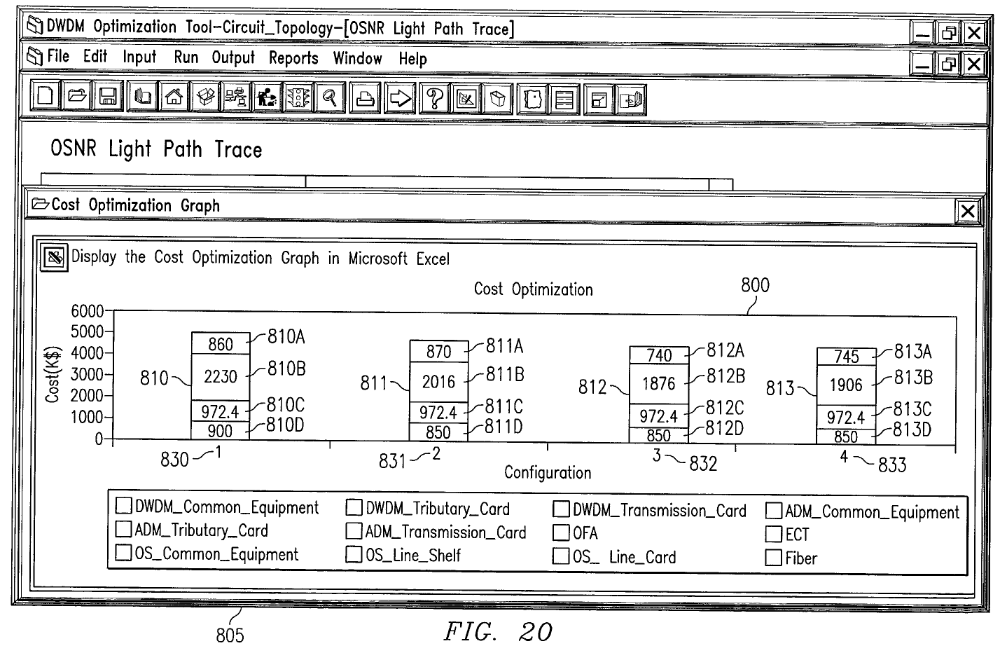

With reference to FIG. 20, there is shown a cost optimization bar chart 800 that may be generated by algorithm 10 and displayed on an output device, such as a cathode ray tube or another display device. The exemplary bar chart 800 is displayed within a graphical user interface provided by a windowing computer system, as is conventional. Bar chart 800 may include a plurality of graphical bars 810-813. An x-axis may specify a particular network configuration and the y-axis may specify the cost of the configuration. Each graphical bar 810-813 may be graphically partitioned into respective subregions 810A-810D - 813A-813D. As described hereinabove, during network design and reconfiguration, individual network components may be selected for placement within the network design and a cost effect of the selection is analyzed. For example, a network cost may be calculated by summing site cost matrices. Site cost matrices are generated by indexing unit (component) prices from a unit price matrix and multiplying the unit price by the number of the associated units selected for the site. Accordingly, the cost of a site is calculated by performing such a routine for each component model selected for the site. As aforedescribed, each network component is categorized according to a general functional type or class. Component class costs may be developed in a manner similar to site costs, namely by multiplying the unit price cost of each component selected from a particular class with the number of that particular component models selected for placement within the network. The numerical value of a component class costs may be converted to a graphical relation and displayed in bar chart 800. In the illustrative example, subregions 810A-813A are graphical representations of optical amplification class costs in a network design and subregions 810B-813D may be representative of transmission card-class components. Similarly, subregions 810C-813C and 810D-813D may be representative of a particular component class cost, such as fiber-class components, tributary card-class components, or other functionally categorized component classifications. Textual and/or numerical information may be provided in conjunction with bar chart 800 to facilitate an easy understanding of the information conveyed to the user. For example, each subregion 810A-810D-813A-813d may have a numerical dollar value included for display within the respective subregion that indicates the dollar amount of all components selected for a particular network configuration from a common equipment class. Numerical identifiers 830-833 may be associated with a particular bar and identify a particular network configuration so that reductions and/or increases in a component-class from one network configuration to another may be easily determined by the user. The cost optimization bar chart 800 is exemplary only and various such graphical outputs for facilitating an understanding of the impact of various network configurations on a network cost are possible. Similarly, graphical output illustrative of RWA variations on the network cost may be generated by algorithm 10.

With reference now to FIG. 21, there is a block diagram of computer system 900, or another apparatus operable to execute a computer-readable instruction set, that may be used to execute algorithm 10 and the various subroutines thereof. Computer system 900 stores algorithm 10 in a memory unit 940. Through conventional techniques, algorithm 10 is executed by an operating system 950 and one or more conventional processing elements 955 such as a central processing unit. Operating system 950 performs functionality similar to conventional operating systems, controls the resources of computer system 900, and interfaces the instructions of algorithm 10 with processing element 955 as necessary to enable algorithm 10 to properly run.

Processing element 955 communicates to and drives the other elements within computer system 900 via a local interface 960, which may comprise one or more buses. Furthermore, an input device 965, for example a keyboard or a mouse, can be used to input data from a user of computer system 900. A disk storage device 980 can be connected to local interface 960 to transfer data to and from a nonvolatile disk, for example a magnetic disk, optical disk, or another device. An output device, such as a printer, cathode ray tube, or another display device, may provide output generated from execution of algorithm 10 by processing element 955 to the user of computer system 900 and algorithm 10.

As described, the present invention provides a computer-aided optical network design that facilitates minimization of wavelength usage and optimization of waveband grouping and sequencing during network design. The present invention models light path characteristics and corresponding signal losses by generation of signal traces to facilitate a network configuration featuring the most economical cost for specified network performance requirements. Calculation and analysis of signal traces provide a technique for determining performance and cost effects of different network components. By varying the light path characteristics of the network design configuration, the impact on overall network performance and cost is evaluated. Minimization of wavelength usage facilitates a reduction in equipment costs at the optical layer by reducing the number of requisite lasers, detectors, and common equipment. Moreover, automated placement of amplification and/or regeneration components within the network design is facilitated by modeling optical signal deterioration that may include signal loss, noise accumulation, and dispersion effects.

While the invention has been particularly shown and described by the foregoing detailed description, it will be understood by those skilled in the art that various changes, alterations, modifications, mutations and derivations in form and detail may be made without departing from the spirit and scope of the invention.

What is claimed is:

1. A method of designing a dense wave division multiplexing network comprised of a plurality of sites, comprising:
specifying a plurality of traffic demands to be serviced by the network;
specifying a plurality of equipment components that are available to be disposed within the network to facilitate delivery of the traffic demands;
assigning at least one of the plurality of components for respective placement within each of the plurality of network sites, the assigned components defining a first network configuration;
computing a network cost value dependent on the selected equipment components;
comparing the computed cost with an alternative cost calculated from an alternative network configuration; and
selecting a final network configuration from the first network configuration and the alternative network configuration.

2. The method according to claim 1, further comprising generating a routing and wavelength assignment for each of the traffic demands, each routing and wavelength assignment respectively comprising a route between a first and second site of the plurality of sites and an optical wavelength carrier for conveyance of the traffic demand therebetween.

3. The method according to claim 2, wherein generating a routing and wavelength assignment further comprises generating a routing and wavelength assignment comprising a route between the first site, the second site, one or more intermediate sites therebetween, and one or more optical wavelength carriers for conveyance of the traffic demand therebetween.

4. The method according to claim 3, further comprising respectively classifying each of the one or more traffic demands as a source traffic, destination traffic, pass-through traffic, and a conversion traffic at each of the first site, the second site, and the one or more intermediate sites.

5. The method according to claim 4, wherein assigning at least one of the plurality of components for respective placement within one of the plurality of network sites further comprises assigning the at least one of the plurality of components for respective placement within one of the plurality of network sites wherein the at least one of the plurality of components is dependent upon a traffic demand classification at the respective site.

6. The method according to claim 1, further comprising:
iteratively varying the assigned components;
recomputing the network cost value dependent on the assigned components; and
recomparing the recomputed cost with a previously computed cost.

7. A method of designing a network configuration, comprising:
designating placement of a plurality of network components within a first network configuration having a plurality of sites and a respective physical link interconnecting two of the plurality of sites;
modeling conveyance of an optical signal along a light path between at least two sites of the first network configuration, the modeled optical signal comprising a calculated signal attribute at a plurality of locations, the value of the calculated signal attribute at any of the plurality of locations dependent upon designation of a set of the network components included within the light path; and
determining a position for potential placement of at least one of an amplification stage and a regeneration stage within the first network configuration.

8. The method according to claim 7, further comprising:
recalculating the signal attribute; and
evaluating, by analysis of the recalculated signal attribute, whether placement of at least one of the amplification stage and the regeneration stage within the network configuration is required.

9. The method according to claim 7, wherein designating placement of a plurality of network components comprises designating placement of one or more network components within each of the plurality of sites.

10. The method according to claim 7, wherein modeling conveyance of an optical signal along a light path between at least two sites further comprises modeling conveyance of the optical signal along the light path comprised of an optical path through a first plurality of components designated for placement in the first site, a second plurality of components designated for placement within the second site, and an optical fiber interconnecting the first and second sites.

11. The method according to claim 10, wherein modeling conveyance of an optical signal further comprises calculating the signal attribute as a power level at the respective locations of the configuration corresponding to each of the first and second plurality of components.

12. The method according to claim 11, wherein calculating the signal attribute as a power level further comprises calculating a power mean and a design criteria at each of the respective locations.

13. The method according to claim 11, wherein the calculated power level further comprises a calculated mean power level and a calculated variance.

14. The method according to claim 7, wherein modeling conveyance of an optical signal along a light path between at least two sites of the first network configuration further comprises calculating a distortion signal attribute at the plurality of locations, the value of the calculated distortion signal attribute at any of the plurality of locations dependent upon designation of a set of the network components included within the light path.

15. The method according to claim 14, wherein calculating a distortion signal attribute further comprises calculating at least one of a jitter value, a polarization mode dispersion value, a chromatic dispersion value, a crosstalk value, and an optical signal to noise ratio value at the plurality of locations.

16. The method according to claim 7, wherein determining a position for potential placement of at least one of an amplification stage and a regeneration stage within the first network configuration further comprises comparing the calculated signal attribute at the plurality of locations with a respective input requirement at the plurality of locations.

17. The method according to claim 7, further comprising assigning each of a plurality of subscriber traffic demands to a respective routing and wavelength assignment, each of the routing and wavelength assignments defining a respective optical traffic demand.

18. The method according to claim 17, wherein assigning each of a plurality of subscriber traffic demands to a respective routing and wavelength assignment further comprises classifying each of the optical traffic demands as an origination traffic demand, a destination traffic demand, a pass-through traffic demand, and a conversion traffic demand at any of the plurality of sites included in the respective routing assignment of the optical traffic demand.

19. The method according to claim 18, wherein designating placement of a plurality of network components comprises designating placement of a plurality of network components within at least one of the plurality of sites.

20. The method according to claim 19, wherein designating placement of a plurality of network components within at least one of the plurality of sites further comprises designating placement of the plurality of network components dependent upon the classification of the optical traffic demand at the at least one of the plurality of sites.

21. The method according to claim 8, wherein recalculating the signal attribute further comprises recalculating the signal attribute at the plurality of locations.

22. The method according to claim 21, wherein recalculating the signal attribute at the plurality of locations further comprises recalculating the signal attribute at the position for potential placement, the position included within the light path.

23. The method according to claim 21, wherein modeling the optical signal further comprises modeling a plurality of optical signals each having a respective light path corresponding to one of the respective routing assignments.

24. The method according to claim 23, wherein modeling the plurality of optical signals and determining the position for potential placement of the at least one of the amplification stage and the regeneration stage is performed iteratively.

25. The method according to claim 23, wherein evaluating whether placement of at least one of the amplification stage and the regeneration stage within the network configuration is required further comprises determining placement of the regeneration stage at the position is required.

26. The method according to claim 24, further comprising:
designating the regeneration stage for removal from the network configuration; and
recalculating the optical signal models.

27. The method according to claim 26, further comprising withdrawing the designation upon determining each of the modeled optical signals has a calculated signal attribute determined to be respectively within an acceptable value range for proper network performance.

28. The method according to claim 26, further comprising:
determining that at least one of the modeled optical signals has a respective calculated signal attribute that is not within an acceptable value range for proper network performance; and
removing the designation from the regeneration stage.

29. The method according to claim 23, further comprising:
designating an amplification stage for removal from the network configuration;
recalculating the optical signal models; and
comparing, for each of the optical signal models, the signal attribute calculated at each of the plurality of locations with a threshold respectively associated with each of the plurality of locations, the signal attribute calculated as a signal power level value.

30. The method according to claim 29, further comprising removing the designation upon determining at least one of the modeled optical signals has a calculated signal power level below the predefined threshold associated with at least one of the plurality of locations.

31. The method according to claim 29, further comprising removing the designated amplification stage from the network configuration upon determining that each of the modeled optical signals has a respective calculated signal power level value that exceeds the predefined threshold.

32. The method according to claim 26, wherein determining a position for placement of at least one of an amplification stage and a regeneration stage further comprises determining a position for placement of one of a regeneration stage and a dispersion compensation module based upon a calculated dispersion signal attribute of the modeled optical signals.

33. The method according to claim 23, further comprising:
calculating a count of regeneration stages required to maintain each of the calculated dispersion signal attributes below of a predefined maximum allowable dispersion threshold; and
calculating a count of dispersion compensation modules required to maintain each of the calculated dispersion signal attributes below the predefined maximum allowable dispersion threshold.

34. The method according to claim 33, further comprising:
calculating a first cost of the regeneration stages;
calculating a second cost of the dispersion compensation modules; and
selecting placement of one of the regeneration stages and the dispersion compensation modules based on a comparison of the first and second cost.

35. The method according to claim 13, wherein modeling conveyance of an optical signal along a light path further comprises calculating the signal attribute at the plurality of locations each respectively corresponding to one of an input and output of one of the plurality of network components.

36. The method according to claim 30, further comprising evaluating whether the signal power level exceeds an input threshold of the amplification stage.

37. The method according to claim 36, further comprising adjusting an attenuation value of a preamplifcation stage upon a determination that the signal power level exceeds the input threshold of the amplification stage.

38. The method according to claim 36, further comprising iteratively performing additional recalculations of the optical signal models and adjusting an attenuation value of a pre-amplification stage until the power level fails to exceed the input threshold.
